(19) United States
(12) Patent Application Publication
(10) Pub. No.: US 2024/0352369 A1
(43) Pub. Date: Oct. 24, 2024

(54) METHODS AND SYSTEMS FOR TREATING BIOMASS COMPOSITIONS

(71) Applicant: Bruso LLC, Hegins, PA (US)

(72) Inventor: Bruce Lee Bruso, Hegins, PA (US)

(21) Appl. No.: 18/640,532

(22) Filed: Apr. 19, 2024

Related U.S. Application Data
(60) Provisional application No. 63/497,370, filed on Apr. 20, 2023.

(51) Int. Cl. C10L 5/44; C05F 5/00; C05G 5/27; C08H 8/00; C08L 23/06; C08L 23/12; C08L 97/02; C10L 1/02; C10L 5/04; C10L 5/36; C10L 5/46; D21C 11/00

(52) U.S. Cl. CPC C10L 5/442; C05F 5/004; C05G 5/27; C08H 8/00; C08L 23/06; C08L 23/12; C08L 97/02; C10L 1/02; C10L 5/04; C10L 5/363; C10L 5/46; D21C 11/0007; C08L 2207/062; C08L 2207/20; C10L 2200/0476

(57) ABSTRACT

Methods and systems disclosed herein can treat biomass compositions to produce valuable products, reduce emissions, and decarbonize biomass. The biomass compositions can be raw biomass (e.g., green, woody-plant derived) or waste biomass (e.g., industrial waste, pulp and paper processes, construction materials). The biomass compositions can be mixed with a reagent to form a mixture. The reagent can include ammonia. The mixture can be reacted to separate one or more components from the biomass and form a treated biomass composition. The one or more components can include lignin, polylactic acid, carbon oxides, methane, minerals, volatiles, or semi-volatiles. The treated biomass can be dried and processed into heating pellets that have higher calorific value and fewer emissions than conventional heating chips. The separated components can be used to produce valuable products, such as wood composites, bioplastics, fertilizer, fuels, lignin anodes for batteries, additives, glues, resins, and bio-based carbon fiber.

### CROSS-REFERENCE

This application claims the benefit of U.S. Provisional Application No. 63/497,370, filed Apr. 20, 2023, which is incorporated herein in its entirety by reference thereto.

### FIELD

This disclosure relates to methods and systems for treatment of and enhancement of biomass compositions. More particularly, the disclosure relates to systems and methods for producing products from raw biomass and/or waste biomass, and to capture environmentally sensitive and/or toxic materials from the biomass.

### BACKGROUND

Biomass is a renewable energy source. However, biomass can exists in waste products in all forms and contain pollutants that are environmentally sensitive or toxic materials, such as volatiles, semi-volatiles, and carbon oxides. Untreated raw biomass, when burned, landfilled, or land-applied, often emits harmful pollutants. Untreated waste biomass can likewise emit harmful pollutants when burned, landfilled, or land-applied, and increase costs related to disposal and increase environmental harm and liability.

### BRIEF SUMMARY

Some embodiments are directed to a method for treating a biomass composition, the method including providing a biomass composition comprising at least one of lignin, cellulose, or hemi-cellulose, pectin, or polysaccharides; mixing the biomass composition with a reagent to form a mixture, wherein the reagent comprises ammonia; reacting the mixture for a first time period; separating a component of the biomass composition to form at least one product (e.g., an environmental and/or commercially-beneficial product), wherein the component comprises at least one of lignin, polylactic acid, carbon oxides, methane, minerals, volatiles, semi-volatiles, graphene, pectin, polysaccharides, hydrocarbons, hemi-cellulose, bio-derived polymer products, torrefied fiber, charred fiber, or liquid biofuel; and removing the at least one product from the mixture.

In any of the various embodiments disclosed herein, the biomass composition comprises dimensional lumber. In any of the various embodiments disclosed herein, the at least one product comprises treated dimensional lumber. In any of the various embodiments disclosed herein, the biomass composition comprises raw biomass. In any of the various embodiments disclosed herein, the raw biomass comprises green biomass.

In any of the various embodiments disclosed herein, the biomass composition comprises a waste product.

In any of the various embodiments disclosed herein, the waste product comprises at least one of wood, agricultural residuals, alcohol residuals, industrial waste sludge, paper waste sludge, municipal waste sludge, municipal solid waste digestate, utility poles, dock and mooring support poles and piers, railroad ties, or recycled drywall paper backing.

In any of the various embodiments disclosed herein, the at least one product comprises a refined biomass composition, wherein the refined biomass composition comprises less lignin than the biomass composition.

In any of the various embodiments disclosed herein, the refined biomass composition comprises at least one of a torrefied pellet, a torrefied cube, or a torrefied chip.

In any of the various embodiments disclosed herein, the at least one product comprises lignin desorbed from the biomass composition.

In any of the various embodiments disclosed herein, the at least one product comprises polylactic acid.

In any of the various embodiments disclosed herein, the at least one product comprises a mineral.

In any of the various embodiments disclosed herein, the mineral has an increased transmittance as measured by a spectrophotometer.

In any of the various embodiments disclosed herein, the mineral comprises at least one of potassium, calcium carbonate, titanium dioxide, talc, or aluminum silicate.

In any of the various embodiments disclosed herein, the reagent comprises at least one of permanganate, potassium permanganate, sodium permanganate, sodium borohydride, or a solvated electron solution.

In any of the various embodiments disclosed herein, the reagent is an aqueous solution comprising ammonia.

In any of the various embodiments disclosed herein, the aqueous solution has an ammonia concentration in a range of about 0.5% to about 100%. In any of the various embodiments, the aqueous solution comprises pure ammonia or anhydrous ammonia.

In any of the various embodiments disclosed herein, the aqueous solution has an ammonia concentration in a range of about 1% to about 19%.

In any of the various embodiments disclosed herein, the component is lignin, and wherein from about 1% to about 99% of the lignin is separated from the biomass composition.

In any of the various embodiments disclosed herein, the first time period is from about 2 minutes to about 48 hours.

In any of the various embodiments disclosed herein, the method produces from about 100 lbs to about 150 tons per hour of the at least one product.

In any of the various embodiments disclosed herein, the reacting occurs at ambient temperature.

In any of the various embodiments disclosed herein, the reacting occurs at atmospheric pressure.

In any of the various embodiments disclosed herein, the reacting is done in a reactor, wherein the reactor has a residence time of about 2 minutes to about 48 hours. In any of the various embodiments disclosed herein, the concentration of the component in the biomass composition is greater than the concentration of the component in the first product.

In any of the various embodiments disclosed herein, the method includes providing the biomass composition at a rate of from about 100 lbs to about 150 tons per hour.

In any of the various embodiments disclosed herein, the carbon oxides comprise at least one of carboxylic acids, carbon dioxide, or carbon monoxide.

In any of the various embodiments disclosed herein, the minerals comprise oxidized minerals.

In any of the various embodiments disclosed herein, the volatiles comprise at least one of hydrocarbons, terpenes, terpenoids, flavonoids, alcohols, aldehydes, and ketones.

In any of the various embodiments disclosed herein, the semi-volatiles comprise at least one of hydrocarbons, aldehydes, ethers, esters, phenols, organic acids, ketones, amines, amides, nitroaromatics, polychlorinated biphenyls, polycyclic aromatic hydrocarbons, phthalate esters, nitrosamines, haloethers and trihalomethanes.

In any of the various embodiments disclosed herein, the calorific heating value of the at least one product is greater than the calorific heating value of the biomass composition.

In any of the various embodiments disclosed herein, the density of the at least one product is greater than the density of the biomass composition.

In any of the various embodiments disclosed herein, the at least one product comprises fewer fine particles.

In any of the various embodiments disclosed herein, the at least one product comprises a higher hydrophobicity than the biomass composition.

In any of the various embodiments disclosed herein, the at least one product comprises a hydrophobicity such that it does not spontaneously combust.

In any of the various embodiments disclosed herein, the biomass composition has a fixed carbon concentration that is less than a fixed carbon concentration of the at least one product.

In any of the various embodiments disclosed herein, the at least one product has a cellulose concentration greater than a cellulose concentration of the biomass composition.

In any of the various embodiments disclosed herein, the cellulose concentration in the at least one product is at least about 100% greater than the cellulose concentration of the biomass composition.

In any of the various embodiments disclosed herein, the cellulose concentration in the at least one product is about 100% to about 200% greater than the cellulose concentration of the biomass composition.

In any of the various embodiments disclosed herein, the reacting the mixture for a first time period comprises hydrogen donation, hydrogen bonding, and hydrogen cleaving.

In any of the various embodiments disclosed herein, the hydrogen donation comprises displacing and transforming carbon oxides in the biomass composition into ammonia salts.

In any of the various embodiments disclosed herein, the hydrogen donation and hydrogen cleaving increases the conversion of Type C1 crystalline polymorphs to Type CIII crystalline polymorphs.

In any of the various embodiments disclosed herein, the hydrogen donation, hydrogen bonding, and hydrogen cleaving in part enables reactions that result in improved strength of mechanical properties and more rapid digestion of the at least one product compared to the biomass composition.

In any of the various embodiments disclosed herein, the hydrogen donation, hydrogen bonding, and hydrogen cleaving allows for hemp decortication, penetration, and decoupling, softening, fiber-polymer compatibility, and conditioning of the fiber.

In any of the various embodiments disclosed herein, the at least one product comprises ammonia, and the concentration of ammonia in the at least one product is greater than a concentration of ammonia in the biomass composition.

In any of the various embodiments disclosed herein, the at least one product is a combustible product comprising ammonia, and wherein the combustible product, when combusted, emits less greenhouse gases than the biomass composition emits when combusted.

In any of the various embodiments disclosed herein, the method is a continuous flow process.

In any of the various embodiments disclosed herein, the cycle time is reduced by at least about 30%. In any of the various embodiments disclosed herein, the cycle time during plastic production is reduced by at least about 30%.

Some embodiments are directed to a heating pellet produced using any of the various methods disclosed herein. Some embodiments are directed to a heating cube produced using any of the various methods disclosed herein. Some embodiments are directed to a heating chip produced using any of the various methods disclosed herein. Some embodiments are directed to a plastic produced using any of the various methods disclosed herein. In any of the various embodiments disclosed herein, the plastic is a recyclable plastic. Some embodiments are directed to a wood composite produced using any of the various methods disclosed herein. Some embodiments are directed to a fuel produced using any of the various methods disclosed herein. Some embodiments are directed to a additive produced using any of the various methods disclosed herein. In any of the various embodiments disclosed herein, the additive is a concrete additive or a cement additive.

Some embodiments are directed to decarbonizing a biomass composition by treating the biomass composition according to any of the various embodiments disclosed herein.

In any of the various embodiments disclosed herein, the biomass composition has a fixed carbon concentration of less than a fixed carbon concentration of the at least one product.

Some embodiments are directed to removing a pollutant from a biomass composition by treating the biomass composition according to any of the various embodiments disclosed herein.

In any of the various embodiments disclosed herein, the pollutant comprises at least one of carboxylic acids, carbon oxides, carbon dioxide, carbon monoxide, methane, oxidized minerals, volatiles, semi-volatiles, pentachlorophenol (PCP), creosote, chlorine, arsenic, short chain hydrocarbons, long chain hydrocarbons, per- and polyfluoroalkyl substances (PFAS), and/or perfluorooctane sulfonic acid (PFOS).

Some embodiments are directed to producing one or more products from a biomass composition, the method including mixing the biomass composition with a reagent to produce a treated biomass composition, wherein the reagent is an aqueous solution comprising ammonia; drying the treated biomass composition to produce at least one product and a gas, wherein the at least one product comprises a first product with a lower CO₂-e concentration and a lower carbon oxide concentration than the biomass composition; and contacting the gas with an absorbent to absorb carbon oxides from the gas, wherein the contacting the gas comprises spraying the absorbent over the gas to absorb carbon oxides in the gas and produce a recycle stream and an exhaust gas stream, wherein the exhaust gas stream comprises less than about 1% concentration of greenhouse gases.

In any of the various embodiments disclosed herein, the time required to dry the treated biomass composition is less than the time required to dry the biomass composition. In some embodiments, the energy required to dry the treated biomass composition is less than the energy required to dry the biomass composition.

In any of the various embodiments disclosed herein, the biomass composition comprises at least one of lignin, cellulose, hemicellulose, or pectin.

In any of the various embodiments disclosed herein, the biomass composition comprises at least one of wood, agricultural residuals, alcohol residuals, industrial waste sludge, paper waste sludge, municipal waste sludge, municipal solid waste digestate, utility poles, dock and mooring support poles and piers, railroad ties, or recycled drywall paper backing.

In any of the various embodiments disclosed herein, the method includes extracting lignin from the biomass composition.

In any of the various embodiments disclosed herein, the aqueous solution has an ammonia concentration in a range of about 1% to about 19%.

In any of the various embodiments disclosed herein, the method includes detecting the concentration of the ammonia in the aqueous solution; determining that the concentration of the ammonia in the aqueous solution is less than a predetermined threshold; and adding ammonia to the aqueous solution.

In any of the various embodiments disclosed herein, the at least one product comprises ammonia in a concentration from about 0.1% to about 3% or from about 0.1% to about 5%.

In any of the various embodiments disclosed herein, the absorbent comprises ammonium hydroxide. In any of the various embodiments disclosed herein, the absorbent comprises pure ammonia.

In any of the various embodiments disclosed herein, the ammonium hydroxide is atomized.

In any of the various embodiments disclosed herein, at least a portion of the ammonia hydroxide is recycled to the reagent.

In any of the various embodiments disclosed herein, the method includes atomizing the absorbent before contacting the exhaust gas with the absorbent.

In any of the various embodiments disclosed herein, the carbon oxide comprises at least one of carbon dioxide, carbon monoxide, methane, or carboxylic acid.

In any of the various embodiments disclosed herein, the method includes mechanically dewatering by applying pressure to the biomass composition to remove moisture from the biomass composition before mixing it with the reagent.

In any of the various embodiments disclosed herein, the method includes diluting the reagent before mixing it with the biomass composition.

In any of the various embodiments disclosed herein, the method includes recirculating the recycle stream to dilute or regenerate the reagent.

In any of the various embodiments disclosed herein, the method is carbon neutral or carbon negative.

In any of the various embodiments disclosed herein, the method includes processing the at least one product to form at least one of a plastic, a wood composite, automotive components, cement additives, concrete additives, renewable fuel, or a fertilizer.

In any of the various embodiments disclosed herein, the at least one product has a higher calorific heating value than the biomass composition.

In any of the various embodiments disclosed herein, the at least one product has a bulk density that is greater than a bulk density of the biomass composition. In any of the various embodiments disclosed herein, the at least one product has an energy density that is greater than an energy density of the biomass composition

In any of the various embodiments disclosed herein, the method captures about 50% to about 90% of the carbon dioxide or carbon dioxide-equivalent compounds in the biomass composition.

Some embodiments are directed to a heating pellet produced using any of the various embodiments disclosed herein. Some embodiments are directed to a heating cube produced using any of the various embodiments disclosed herein. Some embodiments are directed to a heating chip produced using any of the various embodiments disclosed herein.

Some embodiments are directed to a plastic produced using any of the various embodiments disclosed herein. In any of the various embodiments disclosed herein, the plastic is a recyclable bioplastic.

Some embodiments are directed to a wood composite produced using any of the various embodiments disclosed herein.

Some embodiments are directed to a fuel produced using any of the various embodiments disclosed herein.

In any of the various embodiments disclosed herein, the fuel is a nitrogen enhanced and hydrogen enhanced fuel. In any of the various embodiments disclosed herein, the fuel comprises one or more of liquid biocrude fuel, renewable diesel fuel, or drop-in fuel

Some embodiments are directed to an additive produced using produced using any of the various embodiments disclosed herein. In any of the various embodiments disclosed herein, the additive is a concrete additive or a cement additive.

Some embodiments are directed to a system for producing products from a biomass composition, the system including a feed system configured to feed the biomass composition; a mixer configured to mix the biomass composition and a reagent to form a mixture, wherein the reagent comprises ammonia; a dryer configured to dry the mixture to produce a first product and gas; and a spray tower configured to contact the gas with an absorbent to absorb carbon oxides from the gas to form a recycle stream and an exhaust gas, wherein the exhaust gas comprises less than about 1% greenhouse gases.

In any of the various embodiments disclosed herein, the biomass composition comprises at least one of wood, agricultural residuals, alcohol residuals, industrial waste sludge, paper waste sludge, municipal waste sludge, or municipal solid waste digestate, utility poles, dock and mooring support poles and piers, railroad ties, or recycled drywall paper backing.

In any of the various embodiments disclosed herein, the absorbent comprises ammonium hydroxide.

In any of the various embodiments disclosed herein, the ammonium hydroxide is atomized.

In any of the various embodiments disclosed herein, the spray tower is configured to spray the ammonium hydroxide to contact the gas such that the absorbent absorbs the carbon oxides from the gas.

In any of the various embodiments disclosed herein, the system includes a reagent tank for storing the reagent.

In any of the various embodiments disclosed herein, the system includes a dilution tank configured to dilute the reagent to form a diluted reagent.

In any of the various embodiments disclosed herein, the mixer is configured to receive the biomass composition from the feed system and to receive the diluted reagent from the dilution tank.

In any of the various embodiments disclosed herein, the system includes a filter configured to capture dust from the exhaust gas.

In any of the various embodiments disclosed herein, the system includes a press configured to apply pressure to mechanically dewater the biomass composition to reduce the moisture content of the biomass composition.

In any of the various embodiments disclosed herein, the feed system is configured to receive the biomass composition from an industrial process waste stream.

In any of the various embodiments disclosed herein, the industrial process comprises at least one of a pulp and paper process, heating pellet production, construction materials production, automotive materials manufacturing, plastics production, or a power generation facility.

In any of the various embodiments disclosed herein, the system includes a grinding apparatus configured to reduce the particle size of the first product to less than about 100 μm.

Some embodiments are directed to decarbonizing a biomass composition using any of the various embodiments disclosed herein.

### BRIEF DESCRIPTION OF THE FIGURES

FIG. 1 is a flow chart of methods according to some embodiments.

FIG. 2 is a flow chart of methods according to some embodiments.

FIG. 3 is a process flow diagram of systems according to some embodiments.

FIG. 4 is a process flow diagram of systems according to some embodiments.

### DETAILED DESCRIPTION

Biomass is a renewable resource, which makes it a desirable source of energy and other products. However, raw biomass can include components that can make it undesirable for energy and other products. For example, raw biomass can have a high water concentration and contain high concentrations of components that produce significant emissions when used for energy or other products. Biomass waste in all forms contains pollutants that are environmentally sensitive or toxic materials, such as volatiles, semi-volatiles, and carbon oxides. Untreated biomass waste can be disposed of, but disposal increases costs. Existing pre-treatment of biomass generates substantial emissions of various compounds, such as carbon, polyfluoroalkyl substances (PFAS), perfluorooctanoic acid (PFOA), formaldehyde, benzaldehyde, acetaldehyde, 2-propenal, butanol, and butanone, carbon oxides, and greenhouse gas emissions.

Embodiments described herein overcome these and other challenges by providing—among other benefits—systems and methods for producing valuable products and reducing or eliminating emissions from biomass. Moreover, embodiments described herein can be standalone systems or can be easily integrated into existing industrial or manufacturing processes. Embodiments disclosed herein provide methods and systems of low-temperature treatment of biomass compositions in all forms, including raw biomass and waste biomass. Various types of biomass waste can be treated, for example, wood fiber biomass, pulp and paper sludge, and wastes from construction materials. In some embodiments, the biomass compositions can be treated with a reagent, such as ammonia, to separate and desorb components contained in the biomass waste. After desorption, the desorbed components can be converted to benign chemical and/or mineral salts and commercial products. In some embodiments, the treated biomass can be dried to produce upcycled products, and the exhaust gas from the drying process can be further captured, treated, and recycled. Embodiments described herein can result in reduced processing times, steps, and procedures; less required equipment; and lower energy costs. Such benefits can be achieved for various biomass conversion processes, such as torrefaction, pyrolysis, hydrolysis, esterification, fermentation, and hydrothermal.

Embodiments described herein can enable various cost savings and operational benefits, including reduced cycle times; reduction in pigments and colorants needed to make plastics; reduced electricity demand for various processes; and increased steam and electrical capacity for various processes.

In some embodiments, by treating biomass waste, the process reduces disposal cost and can generate additional revenue with the upcycled biomass products. The upcycled biomass products can be used for various purposes, such as renewable energy generation, heating pellets production, hemi-cellulose fiber-reinforced thermoplastic (HCFRTP) composites, plastic wood composites, and automotive composites. The upcycled biomass products can have increased dryer efficiency, increased fiber and structural compaction density, increased tensile and flexural strength, increased durability, increased boiler efficiency, increased heat content (e.g., 30% to 80%), and reduced moisture content (e.g., 35% to 70%). The upcycled products can also resist moisture re-absorption, spontaneous combustion, and biological activity.

In some embodiments, the treatment of biomass waste with a reagent is a chemical process that takes place pre-combustion and does not require heating, thereby reducing carbon emission. In some embodiments, a thermal step is added as a catalyst to the pre-combustion treatment process, and the thermal step can be applied in low temperature. For example, compared to direct air capture systems that capture carbon dioxide and other harmful pollutants after they have already been emitted, embodiments described herein can prevent such pollutants from ever being emitted by treating biomass compositions before combustion. This can be done, for example, using a decarboxylation reaction. Such a reaction breaks carbon bonds and replaces them with ammonia salts. Accordingly, when biomass compositions are treated as described herein and later combusted, the resulting emissions are significantly lower compared to untreated biomass.

Additionally, because certain components can be recycled within the system and the system has a lower latent heat of vaporization, the process has reduced fuel demand and lowers the volume and impact of emissions. This efficiency allows the process to a sustainable and carbon neutral or carbon negative process. The methods disclosed herein produce further value by treating and recycling the separated components. For example, the separated components can be treated and recycled for various products, such as commercial fertilizer, fuel crude, renewable or recyclable bioplastics, and cement strength additive. Therefore, methods disclose herein intake the biomass compositions and output multiple products with higher commercial value and zero waste.

In some embodiments, the systems disclosed herein can be standalone systems. In some embodiments, the systems for treatment of biomass composition can be modular. In some embodiments, the systems for treating biomass can be incorporated in-line with existing industrial equipment, which can reduce the installation cost for existing industrial plants.

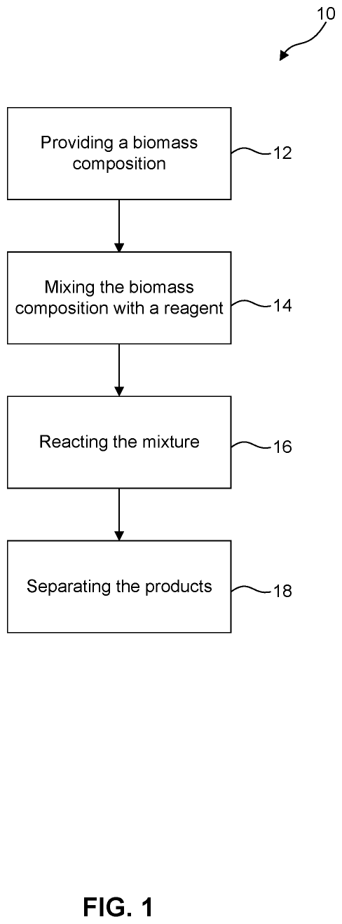

FIG. 1 shows method 10 for treating a biomass composition according to some embodiments. In some embodiments, at step 12, a biomass composition (e.g., biomass composition 1000) is provided to the system. The biomass composition can be provided directly from an existing industrial process. In some embodiments, at step 14, the biomass composition can be mixed with a reagent to form a mixture. In some embodiments, at step 16, the mixture can be reacted in a reactor. In some embodiments, the biomass composition is mixed with the reagent in the reactor. In some embodiments, at step 18, one or more products can be separated from the reacted mixture. The process, biomass composition, reagent, reactor, and products are described in detail below.

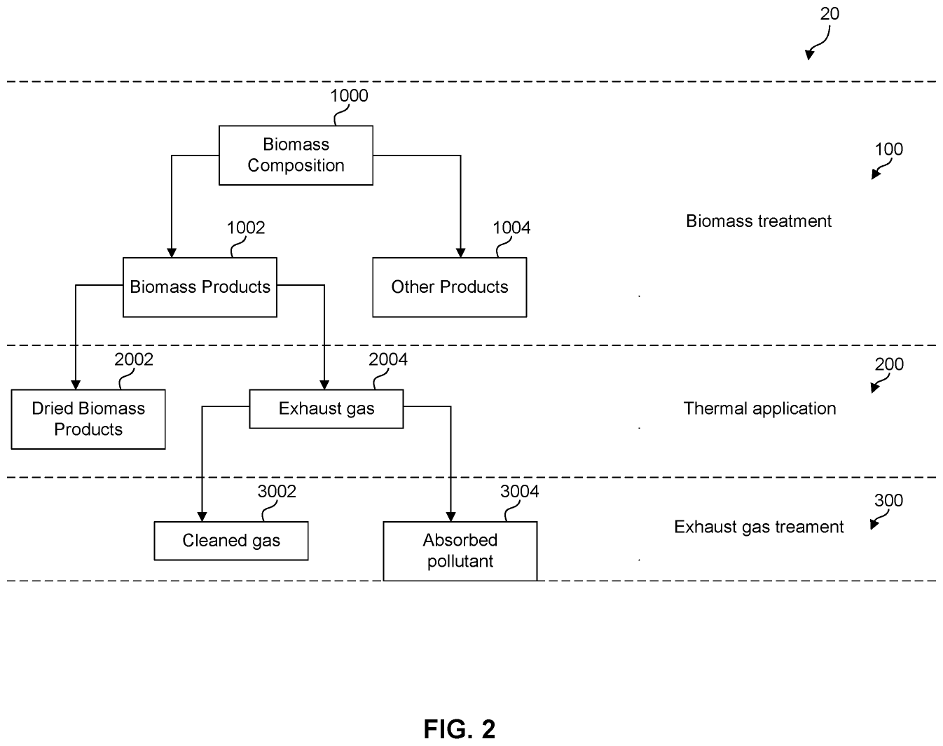

FIG. 2 shows method 20 for treating a biomass composition according to some embodiments. In some embodiments, at step 100, a biomass composition can be treated. In some embodiments, step 100 can be a pre-thermal treatment or a pre-combustion treatment of biomass composition 1000. In some embodiments, at step 200 the treated biomass composition can undergo a thermal application. In some embodiments, at step 300, exhaust gas can be treated in an air capture system.

In some embodiments, the feedstock to method 20 can be biomass composition 1000. During step 100, in some embodiments, biomass composition 1000 can be treated with a reagent to remove and promote separation of components 1004 from biomass composition 1000. In some embodiments, biomass composition 1000 is treated with a reagent in reactor 1050. In some embodiments, method 20 uses 1 or more (e.g., 2 or more, 3 or more, or 4 or more) reactors 1050. In some embodiments, when multiple reactors are used, the reactors can be operated in parallel. In some embodiments, when multiple reactors are used, the reactors can be operated in series. In some embodiments, the outputs of step 100 can include treated biomass composition 1002 and components 1004. In some embodiments, components 1004 can be recycled back to other components of method 20 or components 1004 can be used for additional purposes outside of method 20 (e.g., as products themselves or as precursors to other products). In some embodiments, no heat is applied during step 100. Biomass composition 1000, treated biomass composition 1002, and components 1004 are discussed in more detail below.

During step 200, in some embodiments treated biomass composition 1002 can undergo a thermal application. In some embodiments, the thermal application involves applying heat to treated biomass composition 1002 to produce dried products 2002. In some embodiments, the thermal application is done in a dryer (e.g., dryer 2050). Dryer 2050 and its operating conditions is described in more detail below.

In some embodiments, the dryer inlet temperature is ambient temperature. In some embodiments, the dryer inlet temperature is in a range from about 25° C. to about 450° C., from about 50° C. to about 425° C., from about 100° C. to about 350° C., from about 150° C. to about 250° C., or within a range having any two of these values as endpoints. In some embodiments, treated biomass composition 1002 is heated to a temperature from about 40° C. to about 200° C.

In some embodiments, treated biomass composition 1002 is dried from about 5 minutes to about 5 hours, from about 20 minutes to about 4 hours, from about 30 minutes to about 3 hours, from about 1 hour to about 2 hours, or within a range having any two of these values as endpoints. In some embodiments, treated biomass composition 1002 is dried from about 5 minutes to about 20 minutes. In some embodiments, treated biomass composition 1002 is dried under negative pressure. In some embodiments, treated biomass composition 1002 is dried at a pressure less than 1 Pa. In some embodiments, treated biomass composition 1002 is dried at a pressure from about-1 Pa to about 0.75 Pa, from about-0.5 Pa to about 0.5 Pa, from about 0 Pa to about 0.25 Pa, or within a range having any two of these values as endpoints. The negative pressure improves recovery of ammonia emissions from the drying process. This can improve process efficiency because the recovered ammonia emissions can be reused in the process, as described below related to the recirculation line.

In some embodiments, step 200 generates exhaust gas 2004. In some embodiments, exhaust gas 2004 can be recycled and used, for example, for energy used in the process. In some embodiments, exhaust gas can be captured for further treatment for example at step 300. In some embodiments, the heat applied during step 200 is low temperature.

In some embodiments, exhaust gas 2004 is passed through an air capture system 3050. In some embodiments, exhaust gas 2004 contacts an absorbent to absorb the pollutant gas contained in exhaust gas 2004. In some embodiments, the outputs of step 300 can include absorbed components 3004 and clean gas 3002 that is less of absorbed component 3004. In some embodiments, absorbed components 3004 can be recycled within method 20 or for additional purposes outside of method 20. In some embodiments, absorbed components 3004 comprise ammonia. In some embodiments, absorbed components can be recycled to dilution tank 1058. For example, the system can detect the concentration of ammonia in dilution tank 1058. If the concentration of ammonia is outside of a predetermined range (e.g., about 1% to about 19%) the system can recycle absorbed components 3004 to adjust the concentration of ammonia in dilution tank 1058.

As shown in FIG. 2, method 20 can convert biomass composition 1000 and produce multiple outputs. In some embodiments, the outputs can include one or more of treated biomass composition 1002, components 1004, dried products 2002, clean gas 3002, and absorbed components 3004. In some embodiments, only clean gas 3002 is emitted, and each of other outputs can used for commercial products and/or be recycled.

In some embodiments, treated biomass composition 1002 is a product of method 20. In some embodiments, one or more components 1004 is a product of method 20. In some embodiments, dried products 2002 is a product of method 20.

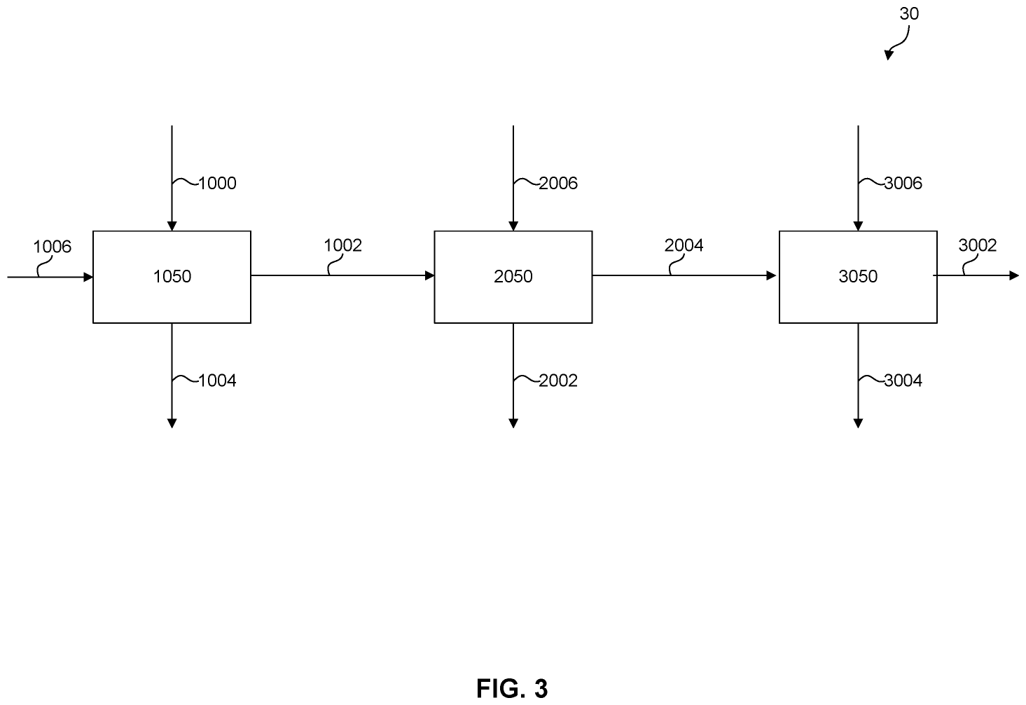

FIG. 3 illustrates a flow diagram for system 30 according to some embodiments. In some embodiments, system 30 can be used for methods 10 or 20. In some embodiments, system 30 can include reactor 1050, dryer 2050, and air capture system 3050. In some embodiments, reactor 1050 receives biomass composition 1000 and reagent 1006. In some embodiments, reactor 1050 outputs treated biomass composition 1002 and components 1004. In some embodiments, treated biomass composition 1002 is transferred to dryer 2050. In some embodiments, energy or heat 2006 is applied to dryer 2050 to dry treated biomass composition 1002 and form dried products 2002 and exhaust gas 2004. In some embodiments, exhaust gas 2004 is transferred to air capture system 3050. In some embodiments, reagent 3006 is provided to air capture system 3050. In some embodiments, reagent 3006 is applied to exhaust gas 2004 in air capture system 3050 to produce clean gas 3002 and absorbed components 3004. In some embodiments, absorbed components 3004 include pollutants removed from exhaust gas 2004. Accordingly, absorbed components 3004 can further reduce greenhouse gas emissions.

In some embodiments, biomass composition 1000 and reagent 1006 are mixed in reactor 1050 to form a mixture. In some embodiments, the mixture is reacted in reactor 1050. Reactor 1050 is described in detail below and its operating conditions are described in more detail below.

In some embodiments, the mixture can be reacted for a time period from about 2 minutes to about 48 hours. In some embodiments, reaction time period corresponds to the residence time of reactor 1050. In some embodiments, the mixture is reacted from about 2 minutes to about 30 minutes, from about 4 minutes to about 20 minutes, from about 2 minutes to about 15 minutes, from about 5 minutes to about 12 minutes, from about 7 minutes to about 10 minutes, or within a range having any two of these values as endpoints. In some embodiments, the mixture can be reacted for about 4 minutes to about 20 minutes. In some embodiments, the mixture can be reacted for about 2 minutes to about 7 minutes. In some embodiments, the mixture can be reacted for about 5 minutes to about 15 minutes. In some embodiments, the mixture can be reacted from about 6 hours to about 48 hours, from about 10 hours to about 36 hours, from about 12 hours to about 30 hours, or from about 18 hours to about 24 hours, or within a range having any two of these values as endpoints. In some embodiments, the mixture can be reacted from about 6 hours to about 48 hours to maximize lignin removal. This can be useful for producing liquid renewable fuels. In some embodiments, the mixture can be reacted from about 2 minutes to about 30 minutes to preserve at least some of the lignin and remove carbon oxides. This can be useful for producing heating pellets, heating cubes, or heating chips.

In some embodiments, the mixture can be reacted at ambient temperature. As used herein, “ambient temperature” means environmental temperature without any added heat or cooling. For example, a reaction that takes place at ambient temperature takes place at the environmental temperature where the reaction takes places without heating or cooling. In some embodiments, the mixture can be reacted at a temperature from about 0° C. to about 40° C., from about 10° C. to about 30° C., from about 15° C. to about 25° C., or within a range having any two of these values as endpoints.

In some embodiments, the mixture is reacted at atmospheric pressure. In some embodiments, the mixture is reacted at a pressure of about 1 Pa.

As described in more detail below, reagent 1006 can include ammonia. In some embodiments, reagent 1006 reacts with biomass composition 1000 to absorb or facilitate absorption of various components (e.g., components 1004) from biomass composition 1000. In some embodiments, components 1004 are desorbed from biomass composition 1000, which produces treated biomass composition 1002 and components 1004. In some embodiments, components 1004 can be recycled back into system 30 or can be used for products outside system 30. In some embodiments, reagent 1006 includes ammonia, sodium permanganate, potassium permanganate, sodium borohydride, ferric chloride, and/or iron, and the resulting reaction can reduce pollutants. In some embodiments, the solution produced is a solvated electron solution that helps with pollutant reduction. In some embodiments, the pollutants that can be reduced include chlorine, PFAS/PFOA, AS, phenols, formaldehyde, CO₂ & CO₂-e compounds, VOC's, Semi-VOC's, PCP (Penta chloro-phenol), and/or Creosote.

In some embodiments, treated biomass composition 1002 is fed from reactor 1050 to dryer 2050. In some embodiments, step 200 of method 20 takes place in dryer 2050. In some embodiments, heat 2006 is applied to treated biomass composition 1002 in dryer 2050 to dry treated biomass composition 1002. In some embodiments, treated biomass composition 1002 releases exhaust gas 2004 during the drying process and becomes dried products 2002. In some embodiments, dried products 2002 can be recycled to system 30. In some embodiments, dried products 2002 can be removed from system 30 and used as a product itself or can be further processed to produce other products. In some embodiments, exhaust gas 2004 can be captured. In some embodiments, at least a portion of exhaust gas 2004 captured from step 200 is heated and can be recycled to fuel dryer 2050. This can reduce the overall energy demand of dryer 2050.

In some embodiments, at least a portion of exhaust gas 2004 is fed into an air capture system 3050. In some embodiments, step 300 of method 20 takes place in air capture system 3050. In some embodiments, in air capture system 3050 includes a spray tower that sprays reagent 3006 to contact exhaust gas 2004 and to absorb the pollutants contained in exhaust gas 2004. In some embodiments, the reagent is an aqueous solution comprising ammonia. In some embodiments, flue gas 3002 is released from system 30 into the environment, and absorbed component 3004 can be recycled either within system 30, used for fuel outside of system 30, or sequestered.

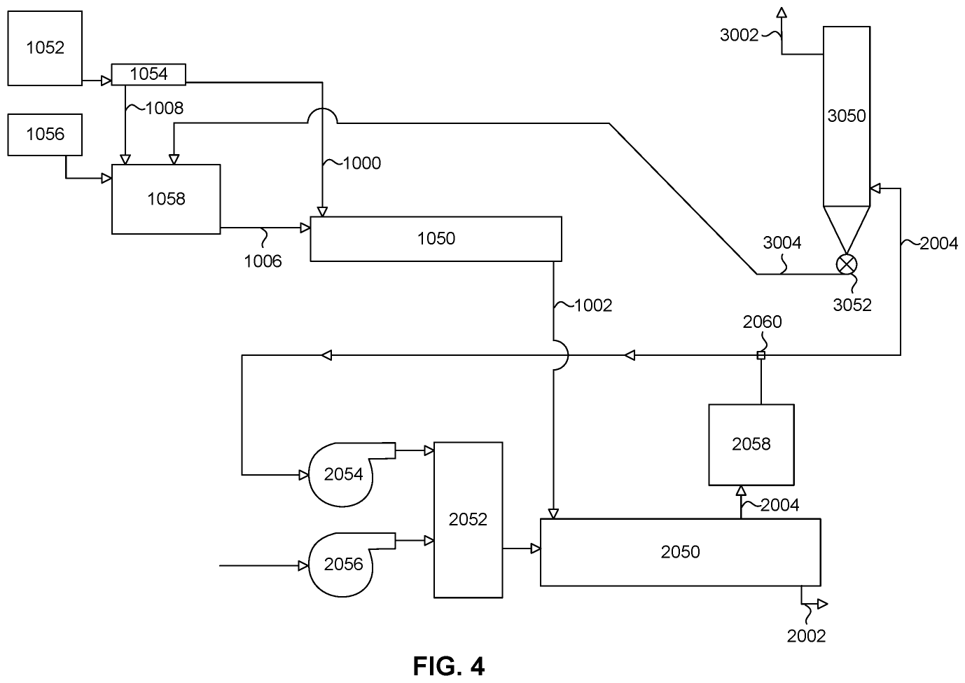

FIG. 4 illustrates system 40 according to some embodiments. In some embodiments, methods 10 and 20 can be carried out using system 40. In some embodiments, system 40 can include one or more of feedstock storage 1052, press 1054, reagent tank 1056, dilution tank 1058, reactor 1050, dryer 2050, fan 2054, fan 2056, dust collection system 2058, valve 2060, air capture system 3050, and pump 3052.

In some embodiments, system 40 includes feedstock storage 1052 for storing biomass composition 1000. In some embodiments, system 40 does not include feedstock storage 1052, and biomass composition is fed directly to one or more presses 1054 or one or more reactors 1050 from an existing process (e.g., a pulp and paper manufacturing process). In some embodiments, biomass composition 1000 is passed from feedstock storage 1052 to press 1054. In some embodiments, biomass composition 1000 is passed to one or more presses 1054 before being fed into reactor 1050 to be mechanically dewatered. In some embodiments, system 40 includes 1 or more (2 or more, 3 or more, or 4 or more) presses 1054 that can be used to dewater biomass composition 1000. In some embodiments, when multiple presses are used, the presses can be operated in parallel. In some embodiments, when multiple presses are used, the presses can be operated in series. In some embodiments, biomass composition 1000 is not passed to press 1054 and is fed directly to reactor 1050. In some embodiments, as described in more detail below, press 1054 can apply pressure to mechanically dewater biomass composition 1000. The dewatering can remove liquid (e.g., liquid 1008) from biomass composition 1000. In some embodiments, reagent 1006 can be stored in reagent tank 1056. In some embodiments, reagent 1006 in reagent tank 1056 is concentrated. In some embodiments, reagent 1006 is diluted in a dilution tank 1058. In some embodiments, liquid 1008 from press 1054 can be used to dilute reagent 1006.

In some embodiments, reagent 1006 and biomass composition 1000 are fed to reactor 1050. Reactor 1050 is described in more detail below. In some embodiments, reactor 1050 produces treated biomass composition 1002 and components 1004. In some embodiments, treated biomass composition 1002 is fed to dryer 2050. In some embodiments, treated biomass composition 1002 is not fed to dryer 2050 and treated biomass composition 1002 is a product of system 30.

In some embodiments, system 40 includes burner 2052 to provide heat to dryer 2050. In some embodiments, dryer 2050 applies heat to treated biomass composition to dry treated biomass composition 1002. In some embodiments, the airflow to burner 2052 is provided from combustion fan 2056, which draws in ambient air, and recirculation fan 2054, which can draw air recycled from within system 40. In some embodiments, system 40 includes dust collection system 2058 to capture exhaust gas 2004 from dryer 2050. In some embodiments, dust collection system 2058 includes a filter. In some embodiments, dust collection system 2058 includes a baghouse. In some embodiments, system 40 includes pumps to direct liquid and air within system 40. In some embodiments, system 40 includes valve 2060. In some embodiments, valve 2060 is a bleed valve. In some embodiments, valve 2060 is actuated to direct exhaust gas 2004 from dryer 2050 to recirculation fan 2054 or air capture system 3050.

In some embodiments, system 40 includes air capture system 3050, which is described in more detail below. In some embodiments, system 40 includes a recycle line that transfers output from air capture system 3050 to dilution tank 1058. In some embodiments, system 40 includes pump 3052 to pump absorbed components 3004 from air capture system 3050 back to dilution tank 1058.

### Feedstock(s)

In some embodiments, the feedstock is a biomass composition (e.g., biomass composition 1000). In some embodiments, biomass composition 1000 can be stored in feedstock storage 1052. In some embodiments, biomass composition 1000 can be transferred directed from an industrial process on a continuous basis. As used herein, “biomass composition” refers to a composition comprising lignin, cellulose, hemicellulose, and/or pectin. In some embodiments, the biomass composition is a raw biomass. The raw biomass can be green, plant-based, plant-derived, and/or woody-plant derived. In some embodiments, the raw biomass comprises green biomass. Green biomass can include unprocessed, wet, raw biomass. For example, green biomass can be freshly harvested biomass. In some embodiments, the biomass composition is a waste product that includes biomass. In some embodiments, the waste product is a waste stream comprising one or more of industrial processes, wastewater processes, at least one of wood, agricultural residuals, alcohol residuals, industrial waste sludge, pulp and paper sludge, municipal waste sludge, municipal solid waste digestate, utility poles, dock and mooring support poles and piers, railroad ties, or recycled drywall paper backing.

In some embodiments, biomass composition 1000 is a biomass composition derived from raw biomass. In some embodiments, biomass composition 1000 is a biomass composition derived from a waste stream. In some embodiments, biomass composition 1000 is a biomass composition comprising a mixture of raw biomass and a waste biomass.

In some embodiments, raw biomass used for feedstock is plant-derived and can include all species of traditional green fiber woody biomass, such as softwoods, hardwoods, bark, and bamboo. In some embodiments, waste biomass used for feedstock can include pulp and paper sludge residues; sugarcane bagasse; industrial hemp; municipal and industrial biosolids; agricultural crops, waste, and residuals; food waste; municipal garbage; animal manure; chicken litter; bio-char and charcoal; peat; cardboard recycling; and wood composites (e.g., oriented strand board (“OSB”)).

In some embodiments, the waste biomass used for biomass composition 1000 can include all forms of waste products comprising biomass. For example, in some embodiments, the waste stream can include pulp and paper sludge, residuals, pulp; agricultural residuals; and boiler fuel.

Biomass waste can contain various components, such as carbon oxides; methane (CH₄); polylactic acid; oxidized mineral; volatiles; semi-volatiles; polyfluoroalkyl substances (PFAS); perfluorooctanoic acid (PFOA). As used herein, carbon oxides means a chemical compound that contains carbon bonded with oxygen. In some embodiments, carbon oxides include carbon dioxide (CO₂), carbon monoxide (CO), carboxyl groups, and carboxylic acids. The biomass wastes, if left untreated, often cannot be recycled for value and also incur disposal costs.

Methods disclosed herein can be incorporated into various industries. In some embodiments, method 20 can be applied to treat building and construction material wastes, such as wood composites. In some embodiments, methods disclosed herein can be incorporated in paper and pulp manufacturing to treat pulp and paper sludge. Pulp and paper sludge is the residual from pulp and paper manufacturing processes and often includes pollutants that are harmful to the environment. Pulp and paper sludge usually includes both organic components, such as wood, cellulose or hemi-cellulose fibers, and lignin, and inorganic components, such as minerals. In some embodiments, methods disclosed herein (e.g., method 20) can extract both the organic components and inorganic components from pulp and paper sludge, in addition to pollutants. Some components, like lignin, have complex structures that make them difficult to break and can be costly and technically challenging to recover. Methods disclosed herein can recover lignin more effectively than conventional methods.

In some embodiments, methods disclosed herein can process biomass composition 1000 at a rate of at least 250 lbs/hr on a continuous basis. In some embodiments, methods disclosed herein can process from about 100 lbs to about 150 tons of biomass per hour, from about 250 lbs to about 80 tons of biomass per hour, from about 500 lbs to about 70 tons of biomass per hour, from about 1 ton to about 60 tons of biomass per hour, from about 10 tons to about 50 tons of biomass per hour, from about 20 tons to about 30 tons of biomass per hour, or within a range having any two of these values as endpoints. In some embodiments, methods disclosed herein can process about 10 tons to about 50 tons of biomass per hour. In some embodiments, methods disclosed herein can process about 30 tons to about 70 tons of biomass per hour. In some embodiments, systems and methods disclosed herein can be used to treat heating pellets at a rate of about 10 tons of heating pellets to about 50 tons of heating pellets per hour. In some embodiments, systems and methods disclosed herein can be used to treat pulp and paper process inputs at a rate of about 30 tons to about 70 tons of pulp and paper process inputs. In some embodiments, systems and methods disclosed herein can be used to treat pulp and paper sludge at a rate of about 10 tons to about 50 tons of pulp and paper sludge per hour.

### Reagent(s)

Biomass composition 1000 can be mixed with a reagent (e.g., reagent 1006) to separate one or more components from the biomass composition. In some embodiments, reagent 1006 used to treat biomass composition 1000. In some embodiments, reagent 1006 comprises ammonia. In some embodiments, reagent 1006 is an aqueous solution. In some embodiments, reagent 1006 is an aqueous solution comprising ammonia. In some embodiments, reagent 1006 comprises ammonia in a concentration of from about 0.1% to about 100%, from about 0.5% to about 100%, or from about 0.5% to about 99%. In some embodiments, reagent 1006 comprises ammonia in a concentration of about 1% to about 19%, such as about 3% to about 15%, or about 7% to about 10%. In some embodiments, reagent 1006 comprises ammonia in a concentration of 100%. In some embodiments, reagent 1006 is pure ammonia. In some embodiments, reagent 1006 is anhydrous ammonia.

In some embodiments, reagent 1006 can be stored in reagent tank 1056. In some embodiments, reagent 1006 in reagent tank 1056 is concentrated. In some embodiments, the concentrated reagent 1006 has an ammonia concentration of about 16% to about 21%. In some embodiments, the concentrated reagent 1006 has an ammonia concentration of about 19%.

In some embodiments, when reagent 1006 is concentrated, reagent 1006 can be diluted in dilution tank 1058. In some embodiments, reagent 1006 is diluted to a target strength based on the type of biomass composition 1000 being treated. In some embodiments, concentrated reagent 1006 can be diluted with a liquid (e.g., water). In some embodiments, reagent 1006 is diluted to an ammonia concentration from about 1% to about 10%, from about 2% to about 7%, from about 3% to about 5%, or within a range having any two of these values as endpoints. In some embodiments, reagent 1006 is diluted to a concentration from about 3% to about 5%. In some embodiments, the liquid used for dilution can come from the liquid extracted from biomass composition 1000 using press 1054, as discussed below. In some embodiments, the liquid used for dilution comes from the liquid leaving air capture system 3050, as discussed below.

In some embodiments, as discussed in more detail below, reagent 1006 can be used to separate, or desorb, components from biomass composition 1000.

### Press(es)

In some embodiments, press 1054 can be used dewater biomass composition 1000 before it is fed to reactor 1050. In some embodiments, the moisture removed from biomass composition 1000 can be directed to dilution tank 1058 to dilute concentrated reagent 1006. In some embodiments, the moisture content of biomass composition 1000 before dewatering can be about 50% to about 80%. In some embodiments, the moisture content of biomass composition 1000 after dewatering by press 1054 can be from about 10% to about 49%, from about 12% to about 40%, from about 14% to about 30%, from about 15% to about 25%, or within a range having any two of these values as endpoints.

In some embodiments, system 30 does not include press 1054, and biomass composition 1000 is fed directly from feedstock storage 1052 to reactor 1050.

### Reactor(s)

In some embodiments, biomass composition 1000 and reagent 1006 are mixed in reactor 1050. In some embodiments, reactor 1050 is a continuous reactor, such that biomass composition 1000 and reagent 1006 are continuously fed into reactor 1050 to produce a continuous stream of outputs. In some embodiments, reactor 1050 is a batch reactor, such that biomass composition 1000 and reagent 1006 are fed into reactor 1050 in batches and the outputs are produced in batches. In some embodiments, reactor 1050 is a semi-batch reactor, such that one of biomass composition 1000 and reagent 1006 is fed continuously, and the other one of biomass composition 1000 and reagent 1006 is fed in batch cycles.

In some embodiments, reactor 1050 is one or more of a low pressure and low heat reactor, centrifuge, paddle reactor, screw type reactor, a dip tank, a pressure vessel, or a spray vessel. In some embodiments, a low pressure, low heat reactor is used to produce liquid products or for solid products. In some embodiments, a centrifuge is used to make liquid products. In some embodiments, the centrifuge is an atmospheric centrifuge. In some embodiments, a heat paddle is used to make solid products (e.g., solid fuel). In some embodiments, a screw type reactor is used to make solid products (e.g., solid fuel).

In some embodiments, reactor 1050 is a dip tank, and biomass composition 1000 can be dipped into reagent 1006 in the dip tank. In some embodiments, reactor 1050 is a dip tank and biomass composition 1000 is dimensional lumber, and the dip tank is configured to receive dimensional lumber. In some embodiments, reactor 1050 is a pressure vessel, and reagent 1006 can be applied to biomass composition 1000 in the pressure vessel. In some embodiments, reactor 1050 is a pressure vessel and biomass composition 1000 is dimensional lumber. In some embodiments, reactor 1050 is a spray vessel and reagent 1006 can be sprayed onto biomass composition 1000 in the spray vessel. In some embodiments, reactor 1050 is a spray vessel and biomass composition 1000 is dimensional lumber.

In some embodiments, reactor 1050 can be operated at various conditions depending on the composition of biomass composition 1000 and/or depending on the desired output of reactor 1050. In some embodiments, reactor 1050 can be operated at ambient temperature. In some embodiments, reactor 1050 can be operated at a temperature from about 0° C. to about 40° C., from about 10° C. to about 30° C., from about 15° C. to about 25° C., or within a range having any two of these values as endpoints.

In some embodiments, reactor 1050 can be operated at atmospheric pressure. In some embodiments, reactor 1050 can be operated at a pressure of about 1 Pa.

In some embodiments, reactor 1050 has a residence time from about 2 minutes to about 48 hours. In some embodiments, reactor 1050 has a residence time from about 2 minutes to about 30 minutes, from about 4 minutes to about 20 minutes, from about 2 minutes to about 15 minutes, from about 5 minutes to about 12 minutes, from about 7 minutes to about 10 minutes, or within a range having any two of these values as endpoints. In some embodiments, reactor 1050 has a residence time from about 4 minutes to about 20 minutes. In some embodiments, reactor 1050 has a residence time from about 2 minutes to about 7 minutes. In some embodiments, reactor 1050 has a residence time from about 5 minutes to about 15 minutes. In some embodiments, reactor 1050 has a residence time from about 6 hours to about 48 hours, from about 10 hours to about 36 hours, from about 12 hours to about 30 hours, or from about 18 hours to about 24 hours, or within a range having any two of these values as endpoints. In some embodiments, when producing solid products (e.g., solid fuels), reactor 1050 has a residence time from about 5 minutes to about 15 minutes. In some embodiments, when producing liquid products (e.g., liquid fuels) or when biomass composition 1000 is being delignified, reactor 1050 has a residence time from about 6 hours to about 48 hours, from about 10 hours to about 36 hours, from about 12 hours to about 30 hours, or from about 18 hours to about 24 hours, or within a range having any two of these values as endpoints.

In some embodiments, when reagent 1006 contacts biomass composition 1000, several types of reactions occur. In some embodiments, the first reaction is that the ammonia contained in reagent 1006 expands the pore structure of the biomass composition 1000 to promote faster contact with the components of biomass composition 1000. Ammonia has a high molecular absorption capacity. For example, at atmospheric temperature and pressure, ammonia is a lixiviant solvent and a Lewis base, creating instantaneous temporary biomass fiber pore or reservoir expansion within the carbonaceous matrix upon contact. This expedites the liquid/gas mass transfer coefficient between the ammonia and internal structure of cellulose, hemi-cellulose, lignin, and/or pectin. Accordingly, expedited liquid/gas mass transfer coefficient eliminates the need for pressure, heat, and/or gaseous ammonia. Following the reaction, the expansion returns to normal dilation. During the reaction, the ammonia solution can donate hydrogen, facilitating a reaction that displaces and transforms carbon oxides into ammonia salts. For example, ammonia has the highest molecular absorption capacity for carbon oxides. Accordingly, after expansion of the pore structure of the biomass composition, the transfer coefficients occur immediately. Ammonia accelerates the temporary expansion of pore space channels and the reservoirs that exist in cellulose and hemi-cellulose. The longer the biomass composition is exposed to reagent 1006, the greater the transfer coefficient and desorption. Various components can be separated, or desorbed, from the biomass composition into the reagent 1006.

Additionally, ammonia is miscible in water and has as higher vapor pressure (expansion) than water as a solvent. When ammonia is used as a pre-treatment to moisture-containing biomass (e.g., as in step 14 shown in FIG. 1 or during biomass treatment 100 shown in FIG. 2), the difference dry bulb temperature and wet bulb temperature is higher compared to untreated moisture-containing biomass. This results in faster evaporation, lower input temperatures, and reduced latent heat of vaporization compared to untreated moisture-containing biomass. This in turn substantially increases the efficiency and volumetric throughput of the dryer (e.g., dryer 2050) during thermal application 200.

In some embodiments, the second reaction is desorption of components from biomass composition 1000. In some embodiments, components from biomass composition 1000 are desorbed into ammonia in reagent 1006. In some embodiments, the components desorbed into the ammonia are converted to ammonia salts. In some embodiments, the transfer coefficient takes place in the reservoirs of biomass composition 1000, such as cellulose or hemi-cellulose of wood or paper fiber. For example in woody biomass and agriculture residuals, the transfer coefficients occur within the cellulose and hemi-cellulose. As another example, in pulp and paper sludge, the transfer coefficients occur in both cellulose and hemi-cellulose reservoirs of the residual paper fiber.

In some embodiments, the third reaction when reagent 1006 contacts biomass composition 1000 is that the volume, prominence, and availability of the oxidized minerals contained in biomass composition 1000 is increased. This can increase the transmittance and yield of valuable minerals contained in biomass composition 1000. In some embodiments, the minerals incudes potassium in wood cellulose and calcium carbonate in pulp and paper sludge. In some embodiments, the potassium and/or calcium carbonate can be used for polymer and plastic production. In some embodiments, the one or more minerals includes at least one of potassium, calcium carbonate, titanium dioxide, talc, or aluminum silicate. In some embodiments, when used for polymer or plastic production, such desorbed minerals can promote the absorption of polymer colorants and pigments, which can decrease the costs related to polymer and plastic production.

In some embodiments, desorbed and absorbed components can be converted to ammonia salts. For example, the carboxylic acids removed from biomass composition 1000 can react with the ammonia in reagent 1006 to form ammonia salts. This conversion to ammonia salts includes a gas-liquid chemical mass transfer coefficient that occurs to form ammonia salts. The mass transfer coefficient increases with temperature, pressure, and superficial gas velocities. In some embodiments, the conversion to ammonia salts can be tested in real-time for compliance with 26 U.S.C. 45Q (2022).

In some embodiments, after the reaction of reagent 1006 and biomass composition 1000 is completed, one or more treated biomass composition 1002 can be output from reactor 1050. In some embodiments, treated biomass composition 1002 can comprise a refined biomass composition. As discussed above, the refined biomass composition has improved properties compared to biomass composition 1000. In some embodiments, one or more products can be moved to dryer 2050. In some embodiments, one or more treated biomass composition 1002 can be moved to dryer 2050 on a conveyor. In some embodiments, and remaining components 1004 can be removed from reactor 1050 and recycled for other purposes. In some embodiments, components 1004 can be recycled for producing bioplastics compounds, liquid commercial fertilizer, solid commercial fertilizer, renewable drop-in fuel, aviation fuel, transportation low-sulfur fuel, renewable diesel fuel crude, lignin anodes for batteries, asphalt binder additives, glues, resins, cement and concrete strength additives, and bio-based carbon fiber.

### Dryer(s)

In some embodiments, step 200 includes a thermal application that takes place in dryer 2050. In some embodiments, the treated biomass composition 1002 can be conveyed from reactor 1050 to dryer 2050. In some embodiments, heat is applied to dry treated biomass composition 1002. The thermal application can be a catalyst to further promote the reaction between reagent 1006 and treated biomass composition 1002. In this process, exhaust gas 2004 can be generated, and treated biomass composition 1002 can be dried to become dried products 2002.

In some embodiments, the inlet temperature of dryer 2050 is ambient temperature. In some embodiments, inlet temperature of dryer 2050 is in a range from about 25° C. to about 450° C., from about 50° C. to about 425° C., from about 100° C. to about 350° C., from about 150° C. to about 250° C., or within a range having any two of these values as endpoints. In some embodiments, dryer 2050 heats treated biomass composition 1002 to a temperature from about 40° C. to about 200° C.

In some embodiments, treated biomass composition 1002 is dryer 2050 operates under negative pressure. In some embodiments, dryer 2050 is dried at a pressure less than 1 Pa. In some embodiments, treated biomass composition 1002 is dried at a pressure from about-1 Pa to about 0.75 Pa, from about-0.5 Pa to about 0.5 Pa, from about 0 Pa to about 0.25 Pa, or within a range having any two of these values as endpoints. The negative pressure improves recovery of ammonia emissions from the drying process. This can improve process efficiency because the recovered ammonia emissions can be reused in the process, as described below related to the recirculation line.

In some embodiments, dryer 2050 can dry treated biomass composition 1002 from about 5 minutes to about 5 hours, from about 20 minutes to about 4 hours, from about 30 minutes to about 3 hours, from about 1 hour to about 2 hours, or within a range having any two of these values as endpoints. In some embodiments, dryer 2050 dries treated biomass composition 1002 from about 5 minutes to about 15 minutes.

In some embodiments, dried products 2002 from dryer 2050 can be used for the production of plastic wood, carbon fiber reinforced thermoplastic (CFRTP) composites, automotive composites, and pellet fuel for industrial and home heating. In some embodiments, lignin is also extracted from dried products 2002. In some embodiments, the lignin includes carboxylic acids. Lignin and other volatiles can heat and create microexplosions during further processes, such as extrusion, of dried products 2002, so it is beneficial to extract lignin from dried products 2002. In some embodiments, the extracted lignin can be useful in the production of bioplastics and biopolymers. For example, the lignin will contain the polylactic acid and graphene extracted from biomass composition 1000.

In some embodiments, a burner 2052 is used to provide heat to dryer 2050. In some embodiments, a combustion fan 2056 draws ambient air into burner 2052. In some embodiments, an additional recirculation fan 2054 draws a portion of exhaust gas 2004 from dryer 2050 into burner 2052. Exhaust gas 2004 can have higher temperature, and therefore improves the heating efficiency of burner 2052.

In some embodiments, dried products 2002 are torrefied pellets, cubes, or chips. In some embodiments, dried products 2002 have higher calorific heating value than biomass composition 1000.

In some embodiments, dryer 2050 comprises a kiln for drying treated biomass composition 1002. In some embodiments, treated biomass composition 1002 is dimensional lumber treated in reactor 1050.

In some embodiments, exhaust gas 2004, which can contain carbon oxides in the form of carbon dioxide, carbon monoxide, and methane, can be captured in a dust collection system 2058 and prevented from emitting into the environment. In some embodiments, valve 2060 can be attached to dust collection system 2058 to control the flow of exhaust gas 2004. In some embodiments, valve 2060 can direct a portion of exhaust gas 2004 to recirculation fan 2054 to be drawn into burner 2052. In some embodiments, valve 2060 can direct a portion of exhaust gas 2004 to air capture system 3050 for further treatment of exhaust gas 2004.

### Products

As described in more detail below, products made using systems and methods disclosed herein can have various improvements and benefits. For example, wood, bioplastics, and plastics can have reduced warpage; better strength parameters; reduced or eliminated moisture absorption; improved moisture resistance; elimination of spontaneous combustion; and improved chemical, heat, and UV resistance. The delignification achieved using systems and methods disclosed herein increases polymer availability by cellulose strength and transfer and can form nano-tubular and lattice structures. The products can also allow for better dispersement and mixing of components of the product; improve drying characteristics; devolatilize construction materials; and create multiple bio-derived products. The products can also be used to produce renewable fuels (both liquids and solids), including hydrogen- and nitrogen-enhanced fuels. These various benefits are described in detail below.

As described above, various components can be separated from biomass composition 1000 to produce treated biomass composition 1002 and/or dried products 2002. In some embodiments, treated biomass composition 1002 and/or dried products 2002 have improved qualities compared to biomass composition 1000. For example, compared to biomass composition 1000, in some embodiments, treated biomass composition 1002 and/or dried products 2002 can have a higher calorific heating value; increased density; reduce fine particles; reduced or eliminated volatiles, semi-volatiles, or carbon oxides; reduced or eliminated lignin concentrations; lower evaporative rate in drying; increased resistance to waster re-absorption; and reduction in or elimination of spontaneous combustion.

In some embodiments, treated biomass composition 1002 and/or dried products 2002 have higher polysaccharides concentration than biomass composition 1000. In some embodiments, the concentration of cellulose, hemi-cellulose, and/or pectin in treated biomass composition 1002 and/or dried products 2002 is greater than the concentration of cellulose, hemi-cellulose, and/or pectin in biomass composition 1000. In some embodiments, the cellulose concentration is increased from about 100% to about 200%, from about 125% to about 175%, from about 150% to about 175%, or within a range having any two of these values as endpoints. In some embodiments, the cellulose concentration is increased by about 170%. In some embodiments, the hemi-cellulose concentration is increased from about 3% to about 25%, from about 5% to about 20%, from about 10% to about 15%, or within a range having any two of these values as endpoints. In some embodiments, the pectin concentration is increased from about 1% to about 25%, from about 2% to about 50%, from about 5% to about 15%, or within a range having any two of these values as endpoints.

In some embodiments, treated biomass composition 1002 and/or dried products 2002 have a higher calorific heating value than biomass composition 1000. In some embodiments, the calorific heating value of treated biomass composition 1002 and/or dried products 2002 is at least 30% higher than the calorific heating value of biomass composition 1000. In some embodiments, treated biomass composition 1002 and/or dried products 2002 have a calorific heating value from about 30% to about 80% (e.g., from about 50% to about 60%) greater than biomass composition 1000. In some embodiments, treated biomass composition 1002 and/or dried products 2002 have a calorific heating value from about 100 BTU/lb to about 12,500 BTU/lb, from about 500 BTU/lb to about 10,000 BTU/lb, from about 1000 BTU/lb to about 7500 BTU/lb, from about 2500 BTU/lb to about 5000 BTU/lb, or within a range having any two of these values as endpoints. In some embodiments, treated biomass composition 1002 and/or dried products 2002 have a calorific heating value from about 7500 BTU/lb to about 12,500 BTU/lb.

In some embodiments, dried products 2002 can have a reduced moisture content. In some embodiments, the moisture content of the dried products 2002 is about 35% to about 70% (e.g., about 45% to about 65% or about 50% to about 60%) less than the moisture content of biomass composition 1000.

In some embodiments, treated biomass composition 1002 and/or dried products 2002 have a higher fixed carbon concentration than biomass composition 1000. As used herein, “fixed carbon concentration” is the mass fraction of non-volatile carbon in the biomass. The fixed carbon in biomass is inside the carbonaceous matrix but can be blocked by deleterious materials, such as carbon oxides. Biomass treated according to embodiments described herein can include less deleterious materials, thus increasing the concentration of fixed carbon in the treated biomass composition and/or dried products compared to biomass composition 1000. In some embodiments, treated biomass composition 1002 and/or dried products 2002 have a fixed carbon concentration from about 1% to about 150% greater than biomass composition 1000. In some embodiments, treated biomass composition 1002 and/or dried products 2002 have a fixed carbon concentration from about 5% to about 140% greater than biomass composition 1000. In some embodiments, treated biomass composition 1002 and/or dried products 2002 have a fixed carbon concentration from about 85% to about 125% greater than biomass composition 1000. In some embodiments, treated biomass composition 1002 and/or dried products have a fixed carbon concentration that is at least about 100% greater than biomass composition 1000.

This increase in cellulose formation is important for the production of biopolymers and bioplastics. For example, the increased cellulose formation facilitates the conversion of Type CI crystalline polymorphs (allomorphs) to Type CIII crystalline polymorphs (allomorphs), which in turn results in increased formation of biopolymers and bioplastic. This also results in improved mechanical properties, such as strength, stress, and impact resistance of the biopolymers and bioplastics compared to a control plastic or polymer. These improved mechanical properties are illustrated in Example 17 below. Further, biopolymers produced using methods disclosed herein can include nanocrystalline cellulose (NCC), long chain cellulose, short chain cellulose, or combinations thereof.

The reactions according to methods disclosed herein result in increased hydrogen donation and cleaving. In some embodiments, the increased hydrogen donation and cleaving expedites conversion of Type C1 crystalline polymorphs (also known as allomorphs of cellulose) to Type CIII crystalline polymorphs (also known as allomorphs of cellulose). Each monomer includes hydroxyl groups that can form hydrogen bonds within the glucan chains (intra-bonding) as well as between chains (inter-bonding). These hydrogen bonds help control and direct (conformation) the crystalline packing as well as increase the physical properties of cellulose. In some embodiments, the expedited conversion of Type CI crystalline polymorphs (allomorphs) to Type CIII crystalline polymorphs (allomorphs) allows for a more digestible cellulose when producing biofuels, biochemicals, and/or bioproducts, which greatly reduces processing and energy costs. In some embodiments, the increased hydrogen cleaving and donation results in an increase in energy density and calorific content in both solid biomass and liquid biofuels produced from biomass. In some embodiments, the increased hydrogen cleaving and donation allows for atmospheric temperature and pressure (low-temperature pyrolysis and fermentation) extraction and de-coupling of lignin and cellulose via low-temperature digestion. This produces a feedstock liquid biocrude fuel that requires much less refining to achieve an SAF (Sustainable Aviation Fuel), renewable diesel, drop-in fuel, and/or natural polymer lignin-based products also containing beneficial nitrogen compounds. In some embodiments, the increased hydrogen cleaving and donation allows for hemp decortication, accelerated fiber penetration, and modification causing inter- and intra-crystalline swelling. This results in better fiber separation, softening, and/or enhancement of fiber-polymer compatibility.

In some embodiments, treated biomass composition 1002 and/or dried products 2002 have a lower carbon oxide concentration than biomass composition 1000. In some embodiments, treated biomass composition 1002 and/or dried products 2002 have a carbon oxide concentration from about 1% to about 99% less than biomass composition 1000. In some embodiments, treated biomass composition 1002 and/or dried products 2002 have a carbon oxide concentration from about 5% to about 70% less than biomass composition 1000. In some embodiments, treated biomass composition 1002 and/or dried products 2002 have a carbon oxide concentration from about 85% to about 100%.

In some embodiments, treated biomass composition 1002 and/or dried products 2002 have a higher density than biomass composition 1000. In some embodiments, treated biomass composition 1002 and/or dried products 2002 have a density from about 2% to about 30% greater than biomass composition 1000. In some embodiments, treated biomass composition 1002 and/or dried products 2002 have a density from about 3 kg/m³ to about 800 kg/m³, from about 5 kg/m³ to about 15 kg/m³, from about 25 kg/m³ to about 50 kg/m³, from about 500 kg/m³ to about 4000 kg/m³, from about 600 kg/m³ to about 3000 kg/m³, from about 700 kg/m³ to about 2000 kg/m³, from about 725 kg/m³ to about 1500 kg/m³, from about 750 kg/m³ to about 1000 kg/m³, from about 760 kg/m³ to about 900 kg/m³, or within a range having any two of these values as endpoints. In some embodiments, the biomass composition 1002 and/or dried products 2002 includes pellets having a density from about 600 kg/m³ to about 650 kg/m³, from about 700 kg/m³ to about 760 kg/m³. In some embodiments, dried products 2002 includes pellets having a density of about 730 kg/m. In some embodiments, the biomass composition 1002 and/or dried products 2002 includes cubes having a density from about 15 kg/m³ to about 25 kg/m³. In some embodiments, dried products 2002 includes cubes having a density of about 35 kg/m³. In some embodiments, the biomass composition 1002 and/or dried products 2002 includes chips having a density from about 5 kg/m³ to about 15 kg/m³. In some embodiments, dried products 2002 includes chips having a density of about 11 kg/m³. In some embodiments, the biomass composition 1002 and/or dried products 2002 includes treated paper sludge having a density from about 500 kg/m³ to about 4000 kg/m³.

In some embodiments, treated biomass composition 1002 and/or dried products 2002 have fewer fine particles than biomass composition 1000. As used herein, “fine particles” means particles with diameters less than or equal to 2.5 μm. In some embodiments, treated biomass composition 1002 and/or dried products 2002 have a concentration of fine particles from about 15% about 35% less than biomass composition 1000.

In some embodiments, treated biomass composition 1002 and/or dried products 2002 have a lower concentration of volatiles than biomass composition 1000. In some embodiments, treated biomass composition 1002 and/or dried products 2002 have a concentration of volatiles from about 10% to about 100% less than biomass composition 1000.

In some embodiments, treated biomass composition 1002 and/or dried products 2002 have a lower concentration of semi-volatiles than biomass composition 1000. In some embodiments, treated biomass composition 1002 and/or dried products 2002 have a concentration of semi-volatiles less than biomass composition 1000.

In some embodiments, treated biomass composition 1002 and/or dried products 2002 have a lower concentration of lignin than biomass composition 1000. In some embodiments, biomass composition 1000 has a lignin concentration from about 15% to about 40% or from about 25% to about 35%. Methods and systems disclosed herein can control the lignin concentration in the output products (e.g., biomass composition 1002, components 1004, and/or dried products 2002). In some embodiments, treated biomass composition 1002 and/or dried products 2002 have a concentration of lignin from about 50% to about 100% less than biomass composition 1000.

In some embodiments, treated biomass composition 1002 and/or dried products 2002 have a lower evaporative rate than biomass composition 1000. In some embodiments, treated biomass composition 1002 and/or dried products 2002 have an evaporative rate less than biomass composition 1000. In some embodiments, this reduction in evaporate rate corresponds to increased throughput (e.g., increased processing rates of biomass composition 1000, increased products rates of products, etc.) and reduced dryer emissions. In some embodiments, the throughput can be increased by from about 25% to about 50%. In some embodiments, emissions from dryer 2050 can be reduced by from about 10% to about 92% compared to emissions from biomass composition 1000.

In some embodiments, treated biomass composition 1002 and/or dried products 2002 can have a higher hydrophobicity than biomass composition 1000. In some embodiments, the hydrophobicity is increased to point that the treated biomass 1002 and/or dried products 2002 does not spontaneously combust. In some embodiments, treated biomass composition 1002 and/or dried products 2002 have a water absorption capacity from less than biomass composition 1000. The increased hydrophobicity is useful in applications such as composite decking. For example, composite decking produced by methods and systems disclosed herein can have longer longevity due to decreased water penetration.

In some embodiments, treated biomass composition 1002 and/or dried products 2002 can be used to make additives for plastics and polymer production. These additives can be used in various plastics and polymers, such as polypropylene, high density polyethylene, low density polyethylene (LDPE), nylon, polyvinyl chloride (PVC), polyester, phenolic, alkyd, polycarbonate, polyamide, polyurethane, silicone, epoxy, acrylic, and polystyrene. In some embodiments, the additive is added to the carrier resin used for making the plastics or polymers. The additive can be used with typical carrier resins and combined into biopolymer or bioplastic products. In some embodiments, the additive is mixed with carrier resins and combined into biopolymer or bioplastic products in a ready-to-mold master batch. In some embodiments, the additive is added to the carrier resin at a concentration from about 10% to 100%, from about 20% to about 90%, from about 30% to about 70%, from about 40% to about 60%, from about 10% to about 50%, or within a range having any two of these values as endpoints. In some embodiments, the additive is added to the carrier resin at a concentration of about 10%. In some embodiments, the additive is added to the carrier resin at a concentration of about 20%. In some embodiments, the additive is added to the carrier resin at a concentration of about 30%. In some embodiments, the additive is added to the carrier resin at a concentration of about 40%. In some embodiments, the additive is added to the carrier resin at a concentration of about 50%.

As shown below in Example 17, additives made from treated biomass composition 1002 and/or dried products 2002 can increase various strength parameters, such as break stress, modulus, break strain, max energy, max stress, max load, modulus, impact resistance, and bulk density.

In some embodiments, plastics and polymers that include additives made from treated biomass composition 1002 and/or dried products 2002 have a higher break stress than plastics and polymers without the additive. In some embodiments, the break stress is from about 20% to about 100% higher, from about 40% to about 80% higher, from about 50% to about 70% higher, or within a range having any two of these values as endpoints. In some embodiments, the break stress is from about 1600 psi to about 4000 psi, from about 1700 psi to about 3800 psi, from about 2000 psi to about 3600 psi, from about 2500 psi to about 3500 psi, from about 2600 psi to about 3000 psi, or within a range having any two of these values as endpoints. In some embodiments, the break stress is about 2900 psi to about 3800 psi.

In some embodiments, plastics and polymers that include additives made from treated biomass composition 1002 and/or dried products 2002 have a higher modulus than plastics and polymers without the additive. In some embodiments, the modulus is from about 15% to about 125% higher, from about 25% to about 100% higher, from about 40% to about 85% higher, from about 60% to about 75% higher, or within a range having any two of these values as endpoints. In some embodiments, the modulus is from about 60,000 psi to about 220,000 psi, from about 80,000 psi to about 200,000 psi, from about 120,000 psi to about 160,000 psi, from about 150,000 psi to about 500,000 psi, from about 150,000 psi to about 450,000 psi, from about 200,000 psi to about 350,000 psi, from about 250,000 psi to about 350,000 psi, or within a range having any two of these values as endpoints.

In some embodiments, plastics and polymers that include additives made from treated biomass composition 1002 and/or dried products 2002 have a higher max energy than plastics and polymers without the additive. In some embodiments, the max energy is from about 10% to about 50% higher, from about 15% to about 35% higher, from about 20% to about 30% higher, or within a range having any two of these values as endpoints. In some embodiments, the max energy is from about 75 in-lb/in³ to about 200 in-lb/in³, from about 100 in-lb/in³ to about 180 in-lb/in³, from about 120 in-lb/in³ to about 160 in-lb/in³, or from about 125 in-lb/in³ to about 140 in-lb/in³, or within a range having any two of these values as endpoints.

In some embodiments, plastics and polymers that include additives made from treated biomass composition 1002 and/or dried products 2002 have a higher max stress than plastics and polymers without the additive. In some embodiments, the max stress is from about 5% to about 40% higher, from about 10% to about 30% higher, from about 15% to about 20% higher, or within a range having any two of these values as endpoints. In some embodiments, the max stress is from about 3000 psi to about 8000 psi, from about 3500 psi to about 7000 psi, from about 4000 psi to about 6500 psi, from about 5000 psi to about 6000 psi, or within a range having any two of these values as endpoints.

In some embodiments, plastics and polymers that include additives made from treated biomass composition 1002 and/or dried products 2002 have a higher max load than plastics and polymers without the additive. In some embodiments, the max load is from about 10% to about 40% higher, from about 15% to about 35% higher, from about 20% to about 25% higher, or within a range having any two of these values as endpoints. In some embodiments, the max load is from about 8 lbs to about 25 lbs, from about 9 lbs to about 20 lbs, from about 10 lbs to about 18 lbs, from about 12 lbs to about 15 lbs, or within a range having any two of these values as endpoints.

In some embodiments, plastics and polymers that include additives made from treated biomass composition 1002 and/or dried products 2002 have a higher impact resistance than plastics and polymers without the additive. In some embodiments, the impact resistance is from about 20% to about 40% higher, from about 15% to about 35% higher, from about 20% to about 25% higher, or within a range having any two of these values as endpoints. In some embodiments, the impact resistance is from about 0.4 ft-lbs/in to about 2.5 ft-lbs/in, from about 0.5 ft-lbs/in to about 2 ft-lbs/in, from about 1 ft-lbs/in to about 1.5 ft-lbs/in, or within a range having any two of these values as endpoints.

In some embodiments, plastics and polymers that include additives made from treated biomass composition 1002 and/or dried products 2002 have a higher bulk density than plastics and polymers without the additive. In some embodiments, the bulk density is from about 1% to about 25% higher, from about 4% to about 20% higher, from about 5% to about 18% higher, from about 10% to about 15% higher, or within a range having any two of these values as endpoints. In some embodiments, the bulk density is from about 0.93 g/cm³ to about 1.2 g/cm³, from about 0.94 g/cm³ to about 1.1 g/cm³, from about 0.97 g/cm³ to about 1.1 g/cm³, from about 0.98 g/cm³ to about 1.0 g/cm³, or within a range having any two of these values as endpoints. In some embodiments, the cycle time required to product the additives is reduced by about 30%. In some embodiments, the energy required to make plastics and polymers using the additive is reduced.

In some embodiments, one or more components 1004 can be removed from biomass composition 1000. In some embodiments, components 1004 can include at least one of lignin, polylactic acid, carbon oxides (e.g., carboxylic acid, carbon dioxide, carbon monoxide), methane, minerals, volatiles, semi-volatiles, graphene, pectin or combinations thereof.

In some embodiments, component 1004 includes lignin. In some embodiments, component 1004 comprises lignin and can be used to make battery anodes, polyesters, polyurethanes, resins, transportation fuel, carbon fiber, bioplastic, glue, dispersants, asphalt binders, concrete binders, binders for particleboard or other wood composites, soil conditioner, filler or active ingredient of phenolic resins, adhesives (e.g., for linoleum), vanillin (synthetic vanilla), dimethyl sulfoxide, bio-polymers, bio-plastics, nano-tubular polymers, and plastics. These polymers can be synthesized directly from lignin via functionalization of hydroxyl groups in the lignin structure. The lignin can also be used as blends, such as copolymers and composites. Natural polymers, such as collagen, silk, and cellulose, can be used to fabricate a fiber network in which cells attach and proliferate. In some embodiments, lignin polymerization occurs by a combinatorial radical coupling process. Such a process can be highly flexible in nature and allow processes to incorporate numerous lignin monomers (i.e., beyond monolignols such as coniferyl, sinapyl, and p-coumaryl alcohols) in different combinations to assemble different lignin.

In some embodiments, component 1004 includes graphene. The graphene can be used in the production of bioplastics and/or petroleum-derived plastics. The graphene can create nano-tubular and other structural formations that can improve the strength and melt-flow characteristics of bioplastics and petroleum-derived plastics. For example, the graphene can be used in the production of bioplastics in its entirety or as a resin filler for petroleum derived plastics and polymers, or combinations thereof.

In some embodiments, component 1004 includes polylactic acid. In some embodiments, component 1004 comprises polylactic acid and can be used to make polymer and plastic consumer products that require or utilize polylactic acid structure. The polylactic acid produced according to methods disclosed herein can be stronger than conventional polylactic acid due to interaction between ammonia, lignin, starch, cellulose fibers, and minerals. In some embodiments, the ammonia can be retained, which prevents moisture absorption and hydrolysis. Accordingly, the polylactic acid can be more useful as a renewable polymer. In some embodiments, the polylactic acid is waterproof.

In some embodiments, component 1004 includes lignin. In some embodiments, component 1004 includes carbon oxides. In some embodiments, the carbon oxides comprise at least one of carboxylic acid, carbon dioxide, or carbon monoxide. In some embodiments, component 1004 comprises carbon oxides and can be used to make renewable fuel, fertilizer, concrete additives, chemicals and/or products that can be made using carbon oxides.

In some embodiments, component 1004 includes methane. In some embodiments, component 1004 comprises methane and can be used as an energy source or to make chemicals.

In some embodiments, component 1004 includes one or more minerals. In some embodiments, the one or more minerals includes at least one of potassium, calcium carbonate, titanium dioxide, talc, or aluminum silicate. In some embodiments, component 1004 includes one or more minerals at a concentration from about 5% to about 65%. In some embodiments, component 1004 comprises one or more minerals and can be used to make colorings. In some embodiments, the one or more minerals has an increased transmittance as measured by a spectrophotometer compared to minerals in biomass composition 1000. In some embodiments, the minerals have increased wavelength and absorption capacity. This makes the minerals suitable for pigments in plastic coloring and can lower the cost of plastic coloring.

In some embodiments, component 1004 includes one or more volatile compounds. In some embodiments, the one or more volatile compounds includes at least one of at least one of hydrocarbons, terpenes, terpenoids, flavonoids, alcohols, aldehydes, formaldehyde, and ketones.

In some embodiments, component 1004 includes one or more semi-volatile compounds. In some embodiments, the one or more semi-volatile compounds includes at least one of at least one of hydrocarbons, aldehydes, ethers, esters, phenols, organic acids, ketones, amines, amides, nitroaromatics, polychlorinated biphenyls, polycyclic aromatic hydrocarbons, phthalate esters, nitrosamines, haloethers and trihalomethanes.

In some embodiments, the separation of volatiles and/or semi-volatiles from treated biomass composition 1002 allows for dried products 2002 to be used for wood products, such as lumber. Because the volatiles and/or semi-volatiles are removed, this eliminates offgassing of these compounds (e.g., formaldehyde) in new building construction.

In some embodiments, treated biomass composition 1002 or dried products 2002 includes pellets, cubes, and/or chips. In some embodiments, treated biomass composition 1002 or dried products 2002 is a wood chip. In some embodiments, the wood chip is a heating pellet. In some embodiments, the heating pellet is a torrefied pellet or chip. Torrefied pellets or chips can be produced according to methods disclosed herein without requiring torrefaction gas and tar generation as in traditional methods of producing torrefied pellets or chips. In some embodiments, the heating pellet produced according to methods disclosed herein cost about 25% to about 50% less than heating pellets produced by conventional methods. In some embodiments, the heating pellet is a cube or a chip.

In some embodiments, wood chips produced using systems and methods undergo phytosanitation sufficient to meet the requirements set by the USDA to receive a phytosanitary certificate. In some embodiments, the wood chips are treated to kill nematodes and prevent other biological growth. In some embodiments, the wood chips are phytosanitary wood chips.

In some embodiments, treated biomass composition 1002, component 1004, and/or dried products 2002 can be further refined to produce valuable products or used as a component to form valuable products. In some embodiments, treated biomass composition 1002, component 1004, and/or dried products 2002 can be used in the production of plastic composites, fertilizer, plastic wood composites, fuel, automotive components, or cement or concrete additives.

In some embodiments, treated biomass composition 1002, component 1004, and/or dried products 2002 can be used to make plastic composites. In some embodiments, the plastic composites are thermoplastic composites. In some embodiments, the plastic composites are hemicellulose-based thermoplastic composites. In some embodiments, the plastic composites are derived from at least one of the cellulose, hemi-cellulose, or lignin from biomass composition 1000.

In some embodiments, treated biomass composition 1002, component 1004, and/or dried products 2002 can be used to make a resin (e.g., a multiple antigen peptide (MAP) resin). In some embodiments, the resin is a MAP resin with a 4-branch or 8-branch peptide epitope. The branches can include lysine residue created through a bio-synthetic pathway. The MAP resin can be a precursor to various proteins.

In some embodiments, the resins can be used for various construction materials, such as wood panels, wood composites, insulation, and particleboard. In some embodiments, the resin is used in wood panels, such as plywood, oriented strand board (OSB), laminated veneer lumber (LVL), and impregnated paper. The resins can replace fossil-based phenols in resins in these wood panels.

In some embodiments, treated biomass composition 1002, component 1004, and/or dried products 2002 can be used to make fertilizer. In some embodiments, the fertilizer is a liquid fertilizer. In some embodiments, the fertilizer is a solid fertilizer. In some embodiments, the fertilizer contains both liquid and solid components. In some embodiments, the fertilizer is a commercial grade, guaranteed analysis fertilizer. In some embodiments, the fertilizer is derived from at least one of nitrogen, phosphorus, and potassium compounds in biomass composition 1000.

In some embodiments, treated biomass composition 1002, component 1004, and/or dried products 2002 can be used to make plastic wood composites. In some embodiments, the plastic wood composites are derived from at least one of the cellulose, hemi-cellulose, or lignin from biomass composition 1000. For example, in some embodiments, biomass composition 1000 is a paper sludge waste that can be used to make a plastic wood composite (e.g., a bio-polymer) from the cellulose, hemi-cellulose, and lignin from the paper sludge waste. In some embodiments, the lignin is removed and the remaining cellulose and hemi-cellulose is used to make the plastic wood composite.

In some embodiments, treated biomass composition 1002, component 1004, and/or dried products 2002 can be used to make fuel. In some embodiments, the fuel is a nitrogen enhanced and/or hydrogen enhanced fuel. In other words, the hydrogen and nitrogen values in the fuel are increased. The increased hydrogen contributes to the increase calorific heating value and results in a cleaner combustion gas. The increased nitrogen contributes to a reduction in carbon oxides build up in a combustion engine. In some embodiments, the fuel is diesel fuel crude. In some embodiments, the fuel is renewable. In some embodiments, the fuel is a liquid fuel derived from the lignin, starches and sugars that are separated from biomass composition 1000. In some embodiments, the fuel is a solid fuel derived from the cellulose, hemi-cellulose, and lignin in biomass composition 1000. In some embodiments, biomass composition 1000 is de-carbonized and de-volatilized, and the remaining components (e.g., cellulose, hemi-cellulose, and lignin) are used to make the solid fuel.

In some embodiments, treated biomass composition 1002, component 1004, and/or dried products 2002 can be used to make automotive components.

In some embodiments, treated biomass composition 1002, component 1004, and/or dried products 2002 can be used to make cement additives or concrete additives. In some embodiments, the cement additives or concrete additives increase the strength of the cement or concrete that includes the additives. In some embodiments, the strength of the cement or concrete is from about 5% to about 55% higher when the cement additive or concrete additive is used. This allows for a reduction in the amount of carbon-containing chemical strengtheners that are required in the cement and concrete. In some embodiments, the cement additives and concrete additives are derived from the lignin-ammonia-water reagent recovered from the system (e.g., as absorbed components 3004).

In some embodiments, treated biomass composition 1002, component 1004, and/or dried products 2002 has an ammonia concentration from about 0.1% to about 5% or from about 0.1% to about 3%.

In some embodiments, treated biomass composition 1002 is a refined biomass composition. In some embodiments, treated biomass composition 1002 is what a remains after other components, such as at least a portion of the lignin. In some embodiments, treated biomass composition 1002 has a calorific value in a range from about 500 BTU/lb J/kg to about 10,000 BTU/lb, from about 1000 BTU/lb to about 9000 BTU/lb, from about 2000 BTU/lb to about 8000 BTU/lb, from about 3000 BTU/lb to about 7000 BTU/lb, from about 4000 BTU/lb to about 6000 BTU/lb, or within a range having any two of these values as endpoints.

In some embodiments, treated biomass composition 1002, component 1004, and/or dried products 2002 includes a torrefied, lignin liberated and decoupled fiber. In some embodiments, this fiber is more readily processed into a torrefied or charred “black” pellet, cube or chip with an increased energy density and bulk density compared to biomass composition 1000. In some embodiments, the fiber can be produced continuously and require less processing time and lower energy costs.

### Air Capture System(s)

In some embodiments, step 300 of exhaust gas treatment takes place in air capture system 3050. In some embodiments, air capture system 3050 includes a spray tower. In some embodiments, after exhaust gas 2004 is captured, it can be fed into the spray tower, in some embodiments, a reagent 3006 is sprayed from the spray tower to absorb pollutants contained in exhaust gas 2004. In some embodiments, reagent 3006 can include at least one of ammonium hydroxide or amine solvents. In some embodiments, reagent 3006 reacts with the pollutants (e.g., carbon oxides) contained in exhaust gas 2004 to form liquid ammonium carbonate. In some embodiments, after the reaction of reagent 3006 and exhaust gas 2004 is completed, clean gas 3002 that is less of pollutants are released in to the environment.

In some embodiments, clean gas 3002 has a reduced greenhouse gas content. For example, in some embodiments, clean gas 3002 has a greenhouse gas concentration of less than or equal to 10%, less than or equal to 5%, less than or equal to 1%, or 0%. In some embodiments, the air capture system has a greenhouse gas removal efficiency from about 85% to about 99%, from about 92% to about 95%, or within a range having any two of these values as endpoints. In some embodiments, the air capture system has a greenhouse gas removal efficiency of about 99%. In some embodiments, the air capture system has a carbon oxide removal efficiency of from about 75% to about 92%, from about 80% to about 90%, or from about 85% to about 92%, or within a range having any two of these values as endpoints.

In some embodiments, absorbed components 3004, such as aqueous ammonium carbonate and/or ammonia salts are recycled within system 40. In some embodiments, absorbed components 3004, such as liquid ammonium carbonate is recycled for uses outside of system 30, such as for producing commercial fertilizer, renewable diesel fuel crude, and cement and concrete strength additive.

In some embodiments, the absorbed components 3004 can be recycled to dilution tank 1058 to adjust the ammonia concentration in dilution tank 1058. In some embodiments, a pump 3052 is attached to the outlet of air capture system 3050 to pump absorbed pollutants 3004 back to dilution tank 1058 to dilute concentrated reagent 1006.

In some embodiments, absorbed components 3004 can be used as additives for chemicals, fertilizer, and concrete.

### Particle Size Reduction

Systems disclosed herein can include particle size reduction equipment to reduce particle size of one or more products. In some embodiments, the system includes at least one of a grinder, mill, chopper, pulverizer, or granulator. In some embodiments, the particle size reduction equipment can reduce the particle size of at least one product to less than or equal to about 100 μm. In some embodiments, the particle size reduction equipment can reduce the particle size to from about 1 μm to about 100 μm, from about 5 μm to about 75 μm, from about 10 μm to about 50 μm, from about 20 μm to about 40 μm, or within a range having any two of these values as endpoints.

In some embodiments, systems and methods disclosed herein can be integrated into existing processes, such as a pulp and paper manufacturing process or a power plant.

In some embodiments, systems and methods disclosed herein are integrated into a pulp and paper manufacturing process. In some embodiments, the input to the system was pulp and paper sludge. In some embodiments, the system input was a wood chip and produced a torrefied wood chip. In some embodiments, using pulp and paper sludge as an input creates better homogeneity, optimum shear angles, and full dispersement of the treated paper sludge, for example, as an additive to produce a polymer or bioplastic component. Such dispersement can provide a substantial advance in producing plastics. In some embodiments, treating pulp and paper sludge according to methods disclosed herein results in a stronger and/or waterproof fiber. The increased strength results in increased density, which in turn makes the fiber more resistant to chemical and UV light. The fiber strength can be equal to or greater than carbon fiber. Additionally, treating pulp and paper sludge according to methods disclosed herein can result in a mineral product that is cleaner.

In some embodiments, systems and methods disclosed herein are integrated into a power plant. In some embodiments, the input to the system can be used for power generation for a biomass power plant. In some embodiments, the system can be used in a new biomass power plant or can be used to convert an existing power plant from a different fuel to biomass (e.g., from coal to biomass). In some embodiments, products produced using the system resulted in increased efficiency, fuel savings, and more favorable heat rate. This all results in reduced cost to generate electric power and a reduction in greenhouse gas emissions.

In some embodiments, systems and methods disclosed herein are carbon neutral. As used herein, “carbon neutral” means that the process makes no net release of carbon dioxide to the atmosphere. In some embodiments, systems and methods disclosed herein are carbon negative. As used herein, “carbon negative” means that the process emits less carbon than the amount of carbon that is absorbed.

In some embodiments, systems and methods disclosed herein can be used in existing processes to reduce emissions of various compounds by the existing process, such as sulfur oxides (SOx), nitrogen oxides (NOx), carbon dioxide (CO₂), mercury, chlorine (CL), and sodium oxide.

In some embodiments, the system can reduce SOx emissions by at least 30% (e.g., at least 40%, at least 50%, at least 60%, or at least 70%). In some embodiments, the system can reduce SOx emissions by from about 30% to about 80% (e.g., from about 40% to about 60%).

In some embodiments, the system can reduce NOx emissions by at least 30% (e.g., at least 35%, at least 40%, at least 45%). In some embodiments, the system can reduce NOx emissions by from about 30% to about 50% (e.g., from about 35% to about 45%).

In some embodiments, the system can reduce carbon dioxide emissions by at least 10% (e.g., at least 20%, at least 30%, at least 40%, or at least 50%). In some embodiments, the system can reduce carbon dioxide emissions by from about 30% to about 80% (e.g., from about 40% to about 60%).

In some embodiments, the system can reduce mercury emissions by at least 30% (e.g., at least 40%, at least 50%, at least 60%, at least 70%, at least 80%, at least 90%, or at least 95%). In some embodiments, the system can reduce mercury emissions by from about 30% to about 98% (e.g., from about 40% to about 95%, from about 50% to about 90%, or from about 60% to about 80%).

In some embodiments, the system can reduce CL emissions by at least 30% (e.g., at least 40%, at least 50%, at least 60%, or at least 70%). In some embodiments, the system can reduce CL emissions by from about 30% to about 74% (e.g., from about 40% to about 70% or from about 50% to about 60%).

In some embodiments, the system can reduce sodium oxide emissions by at least 30% (e.g., at least 40%, at least 50%, at least 60%, or at least 70%). In some embodiments, the system can reduce sodium oxide emissions by from about 30% to about 76% (e.g., from about 40% to about 70% or from about 50% to about 60%).

In some embodiments, methods and systems disclosed herein do not require carbon dioxide blow. In some embodiments, cellulose can assist in cooling, which can eliminate the need for a blowing agent and reduce cycle time. As used herein, “cycle time” means the time required to produce a usable product. In some embodiments, cycle time is reduced by from about 10% to about 50%, from about 20% to about 40%, or within a range having any two of these values as endpoints. In some embodiments, cycle time is reduced by about 30%.

In some embodiments, methods disclosed herein can be used to treat lumber (e.g., dimensional lumber). For example, methods disclosed herein can be used to de-carbonize the dimensional lumber and remove target pollutants (e.g., formaldehyde, phenols, CO₂ equivalents carbon oxides, volatiles, semi-volatiles, pentachlorophenol (PCP), creosote, chlorine, arsenic, short chain hydrocarbons, long chain hydrocarbons, carbon dioxide, carbon monoxide, per- and polyfluoroalkyl substances (PFAS), and/or perfluorooctane sulfonic acid (PFOS)) from the dimensional lumber. This results in more sustainable building products. Such treated dimensional lumber can be de-carbonized while also having improved strength and mechanical properties. Additionally, treating dimensional lumber can eliminate offgassing of pollutants after building. Such treated lumber also can have shortened drying and curing times in drying kilns. Additionally, the kiln flue gas emissions and the products of de-carbonization of the lumber can be captured and used to produce commercial products.

In some embodiments, the methods for de-carbonizing dimensional lumber and removing pollutants from the dimensional lumber includes spray applying liquid ammonia to the dimensional lumber; dipping the dimensional lumber in soaking tanks comprising liquid ammonia; and/or feeding the dimensional lumber into pressure treatment vessels that apply liquid ammonia. Using any of these methods, the ammonia is allowed to penetrate throughout the dimensional lumber matrix. After allowing the ammonia to penetrate, any excess liquid ammonia is recycled and/or reused, and the dimensional lumber is dried (e.g., in a wood drying kiln). As discussed above, the kiln flue gas can be captured and used to produce commercial products.

Dimensional lumber can include pollutants, such as carbon dioxide, volatiles, phenols, etc. These pollutants can offgas for a long time after the dimensional lumber has been used or installed (e.g. in a building). In some embodiments, dimensional lumber treated according to embodiments described herein can reduce offgassing by from about 25% to 100%, from about 40% to about 99%, from about 50% to about 75%, or within a range having any two of these values as endpoints. In some embodiments, dimensional lumber treated according to embodiments described herein can reduce offgassing by at least 50%. In some embodiments, dimensional lumber treated according to embodiments described herein can reduce offgassing by about 99%.

### EXAMPLES

### Example 1

In one experiment, pulp and paper sludge was treated according to methods disclosed herein. The resulting product was tested for various PFAS compounds. As shown in Table 1 below, the resulting products contained PFAS concentrations significantly below the maximum allowable levels established by the US EPA.

TABLE 1

| PFAS (polyfluoroalkyl | US EPA maximum | | Example 1 product PFAS | |
|---|---|---|---|---|
| substances) Compound | acceptable levels | | Compound concentrations | |
| PFOA (perfluorooctanoic | 1.26 | mg/kg | 0.00066 | mg/kg |
| acid) | | | | |
| PFOS (perfluorooctane | 1.26 | mg/kg | 0.014 | mg/kg |
| sulfonic acid) | | | | |
| PFOSAm | 1.26 | mg/kg | <0.02 | μg/kg |
| (Perfluorooctanesulfonamide) | | | | |
| PFBS (perfluorobutane | 1600 | mg/kg | 0.00023 | mg/kg |
| sulfonate) | | | | |

### Example 2

In one experiment, a pilot scale study was performed. Based on the pilot study, it was determined that systems disclosed herein can be used to treat pulp and paper sludge at a rate of 80,000 tons per year. Based on the pilot scale study, it was determined that treating 80,000 tons per year of pulp and paper sludge according to methods and systems disclosed herein can reduce enough waste to reduce annual costs by about $5 million due to eliminated landfill transportation and disposal costs, and increased operational efficiencies.

Treating 80,000 tons per year of pulp and paper sludge would eliminate about 53,031 metric tons of CO₂-equivalent per year. The treatment was carbon neutral.

### Example 3

In one experiment, a pilot scale study was performed. Based on the pilot study, it was determined that systems disclosed herein were can be to treat 150,000 tons per year of pulp and paper sludge and pre-treat 3,000,000 tons per year of pulp. Based on the pilot scale study, it was determined that treatment of the pulp and paper sludge at that rate would eliminate about 99,434 metric tons of CO₂-equivalent per year.

### Example 4

In one experiment, systems and methods disclosed herein were used to produce a torrefied chip. The torrefied chip had an improved heat content. The heat content of the torrefied chip ranged from 30% to 80% depending on the biomass. The moisture content of the torrefied chip was 35% to 70% less than the input pulp and paper sludge.

### Example 5

In one experiment, the torrefied chips of Example 4 were fed to the boiler of the pulp and paper manufacturing process of Example 3 and used as fuel for the boiler. The boiler efficiency increased 4% to 12% due to increased steam and power capacity. This reduced the fuel demand by up to 25%. This also reduced the need for wet electrostatic precipitator, regenerative thermal oxidizers, and air pollution control systems. The emissions from the boiler were reduced by up to 92%.

### Example 6

In one experiment, bagasse was treated using systems and methods disclosed herein. For example, the bagasse was treated with ammonia in a reactor according to embodiments disclosed herein. As shown in Table 2 below, the treated bagasse showed decreased moisture content, increased hydrogen content, and increased calorific heating value.

TABLE 2

| | Untreated bagasse | Treated bagasse |
|---|---|---|
| Moisture content (wt %) | 50.00 | 4.88 |
| Carbon, total (wt %) | 39.94 | 44.28 |
| Hydrogen, total (wt %) | 4.90 | 5.50 |
| Nitrogen, total (wt %) | 0.5 | 0.5 |
| Oxygen (wt %) | 36.25 | 39.93 |
| Sulfur, total (wt %) | 0.08 | 0.08 |
| Heating value (gross) as | 3586 | 7446 |
| received (BTU/lb) | | |
| Heating value (gross) | 7172 | 7828 |
| moisture free (BTU/lb) | | |

The moisture content was determined using method ASTM D7582. The carbon, hydrogen, and nitrogen was determined using method ASTM D5373. The oxygen was calculated. The sulfur was determined using method ASTM D4239. The heating value was determined using method ASTM D5865.

### Example 7

In one experiment, the bagasse treatment of Example 6 produced an exhaust gas that was treated in an air capture system including a scrubber. The scrubber treated the exhaust gas with ammonium to remove certain components and to form a liquid stream exiting the scrubber. The slurry was evaluated for various nitrogen, phosphorus, and potassium components. As shown in Table 3 below, the slurry has nitrogen, phosphorus, and potassium values indicative of commercial grade fertilizer.

TABLE 3

| | Concentration | Method |
|---|---|---|
| Nitrate/Nitrite (mg/L) | 0.53 | EPA 353.2 |
| Phosphorus, total | 11.0 | EPA 365.1 |
| (mg/L) | | |
| Total Kjeldahl | 26,500 | S4500NH3G-11 |
| Nitrogen (TKN) | | |
| (mg/L) | | |
| Total nitrogen (mg/L) | 26,500 | Calculated |
| Potassium, total | 71.8 | EPA 200.7 |
| (mg/L) | | |

Accordingly, as shown above, the bagasse input of Example 6 can produce products that can be used for commercial grade fertilizer.

### Example 8

In one experiment, wood heating pellets were analyzed for various characteristics. Those wood heating pellets were then treated using systems and methods disclosed herein and the same characteristics were measured. For example, the wood heating pellets were treated with ammonia in a reactor according to embodiments disclosed herein. As shown in Table 4 below the treatment improved various characteristics of the wood heating pellet compared to the untreated wood heating pellet.

TABLE 4

| | Untreated wood | Treated wood | |
|---|---|---|---|
| | heating pellet | heating pellet | Analytical method |
| Total moisture (%) | 5.42 | 4.10 | ISO 18134-1 |
| Ash (%) | 0.25 | 0.22 | ISO 18122 |
| Gross calorific value | 19.81 | 20.02 | ISO 18125 |
| (GJ/Tonne) | | | |
| Carbon (%) | 49.08 | 49.85 | ISO 16948 |
| Hydrogen (%) | 5.75 | 5.88 | ISO 16948 |
| Nitrogen (%) | 0.11 | 0.20 | ISO 16948 |
| Oxygen (%) | 39.39 | 39.75 | ISO 16948 |
| Sulfur (%) | 0.01 | 0.01 | ISO 16994 |
| Chlorine (%) | <0.005 | <0.005 | ISO 16994 |
| Shrinkage Starting | 1080 | 1070 | ISO 21404 (815 |
| Temperature-SST | | | ° C.) |
| (° C.) | | | |
| Deformation | >1500 | >1500 | ISO 21404 (815 |
| Temperature-DT | | | ° C.) |
| (° C.) | | | |
| Hemispherical | >1500 | >1500 | ISO 21404 (815 |
| Temperature-HT | | | ° C.) |
| (° C.) | | | |
| Flow temperature- | >1500 | >1500 | ISO 21404 (815 |
| FT (° C.) | | | ° C.) |
| Bulk Density (kg/m³) | 732 | 746 | ISO 17828 |
| Pellet Diameter Mean | 6.23 | 6.30 | ISO 17829 |
| (mm) | | | |
| Pellet Length Mean | 12.10 | 15.42 | ISO 17829 |
| (mm) | | | |
| Wt % greater than 40 | 0.00 | 0.00 | ISO 17829 |
| mm length | | | |
| Durability index | 98.0 | 97.7 | ISO 17831-2 |
| Fines (<3.15 mm) (%) | 0.27 | 0.18 | ISO 18846 |

### Example 9

In one experiment, pine was treated using systems and methods disclosed herein. For example, the pine was treated with ammonia in a reactor according to embodiments disclosed herein. As shown in Table 5 below, the treated pine showed decreased moisture content, increased hydrogen content, and increased calorific heating value.

TABLE 5

| | Untreated pine | Treated pine |
|---|---|---|
| Moisture content (wt %) | 41.73 | 5.55 |
| Carbon, total (wt %) | 45.51 | 51.08 |
| Hydrogen, total (wt %) | 3.97 | 4.63 |
| Nitrogen, total (wt %) | 0.29 | 0.34 |
| Oxygen (wt %) | 37.11 | 34.36 |
| Sulfur, total (wt %) | 0.06 | 0.04 |
| Heating value (gross) as | 4871 | 8320 |
| received (BTU/lb) | | |
| Heating value (gross) moisture | 8360 | 8809 |
| free (BTU/lb) | | |

The moisture content was determined using method ASTM D7582. The carbon, hydrogen, and nitrogen was determined using method ASTM D5373. The oxygen was calculated. The sulfur was determined using method ASTM D4239. The heating value was determined using method ASTM D5865.

### Example 10

In one experiment, bark was treated according to systems and methods disclosed here. For example, the bark was treated with ammonia in a reactor according to embodiments disclosed herein. Untreated bark typically requires about 1600 BTU of heat input per pound of water to be dried. The treated bark was tested for the heat input required to remove moisture. The treated bark required from about 800 BTU to about 1200 BTU of heat input per pound of water to be tried. This reduced latent heat of vaporization and delta T provides significant cost reduction. For example, based on this improvement costs can be reduced by 25%-50% and require less fuel for heating.

### Example 11

In one experiment, the steam production was determined for untreated bark used in a boiler and for treated bark used in a 900 psi boiler. The untreated bark was added to a boiler at a rate of about 65 tons/hour and generated about 311,600 pounds of steam per hour. The treated bark was added to a boiler at a rate of about 36.1 tons/hour and generated about 384,300 pounds of steam per hour.

### Example 12

In one experiment, wood heating pellets were analyzed for various characteristics. Those wood heating pellets were then treated using systems and methods disclosed herein and the same characteristics were measured. For example, the wood heating pellets were treated with ammonia in a reactor according to embodiments disclosed herein. As shown in Table 6 below the treatment improved various characteristics of the wood heating pellet compared to the untreated wood heating pellet.

TABLE 6

| | Untreated wood | Treated wood |
|---|---|---|
| | heating pellet | heating pellet |
| Moisture fraction, | 0.076 | 0.068 |
| dimensionless | | |
| O₂ concentration (% | 13.12 | 12.98 |
| dry) | | |
| CO₂ concentration (% | 7.49 | 7.70 |
| dry) | | |
| CO concentration | 5327.87 | 2874.75 |
| (ppmvd) | | |
| NOx concentration | 54.21 | 104.15 |
| (ppmvd) | | |
| SO₂ concentration | 10.21 | 7.54 |
| (ppmvd) | | |
| Hydrogen | 129.69 | 56.04 |
| concentration, total | | |
| (ppmvd) | | |

### Example 13

In one experiment, paper sludge materials were compounded with a thermoplastic materials to create three different samples (Samples A, B, and C). The paper sludge materials used in each sample were from the same source. The paper sludge materials used for Sample A were dried using conventional methods. The paper sludge materials used for Samples B and C were treated (including drying) using systems and methods disclosed herein. The formulations of the compounds is shown in Table 7 below.

TABLE 7

| Materials | Sample A | Sample B | Sample C |
|---|---|---|---|
| 6301 Polypropylene | 70.0 | 70.0 | 68.0 |
| (LyondellBasell) (%) | | | |
| Dried Paper Sludge (conventional | 30.0 | 0.0 | 0.0 |
| drying methods) (%) | | | |
| Dried Paper Sludge (disclosed | 0.0 | 30.0 | 30.0 |
| treatments) (%) | | | |
| Polyolefin (Mitsui, Admer | 0.0 | 0.0 | 2.0 |
| QF551A) (%) | | | |

All samples were compounded using a Werner-Pfleiderer co-rotating, inter-meshing twin screw extruder, 30-millimeter diameter, 945 mm long (31.5:1 L/D), double vented, 20 HP with RPM up to 340, fitted with a K-Tron feeder system; 2 gravimetric feeders (1 twin-screw and 1 single-screw). The dried paper sludge was fed using the twin-screw feeder and the polypropylene was fed using the single-screw feeder.

The compounded materials were cast from the extruder into a water bath, then cut using a Conair Jetro, rotary knife pelletizer. The pellets were dried at about 82° C. in a dehumidifying drier for at least 4 hours prior to injection molding. The test specimens were injection molded on Demag 110-ton injection molding machine with 32 mm barrel and mold for ASTM D-638 Type I bars. These bars were conditioned in a lab environment of 23° C. and 50% relative humidity for at least 40 hours prior to testing. ASTM D-256 Notched IZOD specimens were cut from the center section of these bars.

A vacuum pump was not used to evacuate volatiles from the extruder during compound. This allowed for evaluations of how volatile the fillers behave. Sample A extruded very well, but had a strong, foul odor. Sample B also extruded very well. It had slight odor, but much less odor than Sample A. Material slowly climbed up the atmospheric vent of the extruder during compounding. This is an indication of volatility. Sample C extruded very well, and had about the same amount of odor as Sample B. However, no material came up the vent.

The test results for Samples A, B, and C are shown in Table 8 below, along with certain values for unfilled polypropylene (“Prime PP”).

TABLE 8

| | ASTM | Prime | Sample | Sample | Sample |
|---|---|---|---|---|---|
| Properties | Method | PP | A | B | C |
| Tensile at Yield (psi) | D-638 | 4900 | 3,849 | 3,865 | 3,982 |
| Tensile at Break (psi) | D-638 | | 3,469 | 3,445 | 3,688 |
| Yield Elongation (%) | D-638 | 11 | 4.7 | 4.7 | 4.5 |
| Break Elongation (%) | D-638 | | 8.0 | 7.0 | 6.0 |
| Tensile Modulus (ksi) | D-638 | | 300 | 307 | 320 |
| Tensile Testing Speed | D-638 | 2.0 | 0.2 | 0.2 | 0.2 |
| (inches/minute) | | | | | |
| Flexural Modulus (ksi) | D-790 | | 328 | 335 | 323 |
| Flexural Strength (psi) | D-790 | | 7,077 | 7,215 | 7,284 |
| Secant Modulus (1%) (ksi) | D-790 | 210 | 318 | 324 | 315 |
| Strain at Fail (%) | D-790 | | 5 | 5 | 5 |
| Notched IZOD (23° C.) (ft- | D-256 | 0.6 | 0.91 | 0.94 | 0.89 |
| lbs/in) | | | | | |
| Cold Notched IZOD (−20º F.) | D-256 | | 0.75 | 0.75 | 0.75 |
| (ft-lbs/in) | | | | | |
| Density (g/cm³) | D-792 | 0.9 | 1.07 | 1.06 | 1.06 |
| Mold Shrink (Flow) | D-955 | | 0.015 | 0.016 | 0.014 |
| (inch/inch) | | | | | |
| Mold Shrink (Transverse) | D-955 | | 0.014 | 0.015 | 0.013 |
| (inch/inch) | | | | | |
| Hardness (Shore D) | D-2240 | | 76.0 | 78.0 | 77.0 |

Melt Flow Rate test conditions used were 230° C./2.16 kg. The tensile strength values of the filled samples are approximately 20% lower on average than the unfilled prime polypropylene. However, the unfilled PP was tested at a higher speed than the filled samples, which would contribute to the higher strength value. The elongation properties were also lower, but that is expected in a filled polymer, such as Samples A, B, and C, compared to an unfilled polymer. Overall, the tensile properties of the filled samples are competitive with other polypropylene compounds filled with no aspect ratio fillers, and the properties are still acceptable for many commercial applications.

Secant modulus values for all the filled samples are higher than the unfilled polypropylene. As shown above, the paper sludge has reinforced the polymer such that it helps maintain the impact resistance at cold temperatures. This is useful in applications such as boards for decking.

### Example 14

In one experiment, paper sludge materials were compounded with polypropylene create two different samples (Samples D and E). The paper sludge materials used for Sample D were dried using conventional methods. The paper sludge materials used for Sample E were treated (including drying) using systems and methods disclosed herein. Samples D and E were formulated using polypropylene from different sources (“PP 1” and “PP 2”). Although PP 1 and PP 2 were from different sources, both were homopolymers. The formulations of the compounds is shown in Table 9 below.

TABLE 9

| Materials | PP 1 | PP 2 | Sample D | Sample E |
|---|---|---|---|---|
| FT120WV polypropylene (%) | 100.0 | 0 | 69.8 | 0 |
| (Braskem) | | | | |
| Profax 6331 polypropylene (%) | 0 | 100.0 | 0 | 69.8 |
| (Enpol) | | | | |
| Dried Paper Sludge (conventional | 0 | 0 | 30.0 | 0 |
| drying methods) (%) | | | | |
| Dried Paper Sludge (disclosed | 0 | 0 | 0 | 30.0 |
| treatments) (%) | | | | |
| Antioxidant (%) (Baerlocher) | 0 | 0 | 0.2 | 0.2 |

Each dried paper sludge was injection molded into ASTM test specimens, conditioned, and then tested. Physical properties were evaluated for PP 1, PP 2. Sample D, and Sample E. The physical properties are summarized in Table 10 below.

TABLE 10

| | ASTM | | | | |
|---|---|---|---|---|---|
| Property | Method | PP 1 | PP 2 | Sample D | Sample E |
| Tensile at | D-638 | 5500 | 4900 | 3783 | 4069 |
| Yield (psi) | | | | | |
| Yield | D-638 | 8 | 11 | 4.5 | 3.3 |
| Elongation (%) | | | | | |
| Tensile Testing | D-638 | 2.0 | 2.0 | 0.2 | 0.2 |
| Speed | | | | | |
| (inches/minute) | | | | | |
| Flexural | D-790 | 239 | | 309 | 394 |
| Modulus (ksi) | | | | | |
| Secant | D-790 | | 210 | 301 | 377 |
| Modulus (1%) | | | | | |
| (ksi) | | | | | |
| Notched IZOD | D-256 | 0.69 | 0.6 | 1.05 | 1.00 |
| (23° C.) (ft- | | | | | |
| lbs/in) | | | | | |

As shown above, comparing Samples D and E, the samples made using systems and methods disclosed herein show less loss in tensile strength and a greater improvement in flexural strength and impact resistance than the materials dried in a heated air dryer.

### Example 15

In one experiment, colored plastics were made using plastic pellets containing coloring agents made from minerals extracted from biomass according methods and systems disclosed herein. Compared to plastics made using conventional coloring agents, the plastics in this experiment required about 25% to about 40% less of the coloring agent to achieve the same color as the plastics made using conventional coloring agents.

### Example 16

In one experiment, pulp and paper sludge residual was treated according to methods and systems disclosed herein.

TABLE 11

| | Untreated | Treated | Percentage |
|---|---|---|---|
| Component | biomass | biomass | change |
| Lignin | 1.9% | 1% | −47% |
| Cellulose | 20% | 54% | 170% |

As illustrated above, treating biomass according to methods disclosed herein can result in a large increase in cellulose concentration. Such increases in cellulose can make it easier to ferment and/or digest the product. Additionally, such increases in cellulose are beneficial for production of biofuels. For example, the biofuel yield is directly correlated with the cellulose concentration.

### Example 17

In one experiment, waste paper sludge was treated using methods disclosed herein to make additives that can be mixed with carrier resins. The mixed additive and carrier resins can be used to create bioplastic or biopolymer products, for example an injection mold ready master batch composition. Table 12 below shows the composition of the various tested samples. As shown in Tables 13 and 14, below various strength parameters improve when a polymer includes an additive made using methods disclosed herein. Each sample was tested using the ASTM Method noted in Tables 13 and 14 below.

TABLE 12

| | Polypropylene | High density | Additive |
|---|---|---|---|
| Sample | wt % | polyethylene wt % | wt % |
| PP 3 (control) | 100 | 0 | 0 |
| PP 4 | 90 | 0 | 10 |
| PP 5 | 70 | 0 | 30 |
| PP 6 | 60 | 0 | 40 |
| PP 7 | 50 | 0 | 50 |
| HDPE-1 (control) | 0 | 100 | 0 |
| HDPE-2 | 0 | 90 | 10 |
| HDPE-3 | 0 | 80 | 20 |
| HDPE-4 | 0 | 90 | 10 |
| HDPE-5 | 0 | 70 | 30 |
| HDPE-6 | 0 | 60 | 40 |

Table 13 shows various strength parameters for polypropylene (“PP”) with various percentages of the additive. As shown in Table 13, additives made from biomass that is treated using methods disclosed herein can be added to PP to improve various strength characteristics. For example, as shown above, compared to a PP control (i.e., containing 100% PP), PP made using additives have higher break stress, modulus, break strain, max energy, max stress, max load, impact resistance, and bulk density.

TABLE 13

| | ASTM | | | | | |
|---|---|---|---|---|---|---|
| Property | Method | PP 3 | PP 4 | PP 5 | PP 6 | PP 7 |
| Break Stress (psi) | D-638 | 2016 | 3844 | 3598 | 2922 | 3482 |
| Modulus (psi) | D-638 | 93800 | 114960 | 162240 | 171440 | 209660 |
| Break Strain (%) | D-790 | 4.41 | 4.41 | 4.41 | 3.39 | 4.41 |
| Max Energy (in- | D-790 | 160.80 | 188.90 | 188.90 | 142.76 | 207.54 |
| lb/in³) | | | | | | |
| Max Stress (psi) | D-790 | 6116 | 6984 | 6984 | 6414 | 7712 |
| Max Load (lbs) | D-790 | 15.42 | 17.89 | 17.89 | 17.03 | 19.41 |
| Modulus (psi) | D-790 | 189740 | 233400 | 233400 | 330800 | 458800 |
| Impact Resistance | D-256 | 0.337 | 0.562 | 0.544 | 0.417 | 0.450 |
| (ft lbs/in) | | | | | | |
| Bulk density | D-792 | 0.930 | 0.937 | 1.032 | 1.094 | 1.162 |
| (g/cm³) | | | | | | |

Table 14 shows various strength parameters for high density polyethylene (“HDPE”) with various percentages of the additive. As shown in Table 14, additives made from biomass that is treated using methods disclosed herein can be added to HDPE to improve various strength characteristics. For example, as shown above, compared to a HDPE control (i.e., containing 100% PP), PP made using additives have higher break stress, modulus, break strain, max energy, max stress, max load, impact resistance, and bulk density.

TABLE 14

| | ASTM | | | | | | |
|---|---|---|---|---|---|---|---|
| Property | Method | HDPE 1 | HDPE 2 | HDPE 3 | HDPE 4 | HDPE 5 | HDPE 6 |
| Break Stress (psi) | D-638 | 2013 | 1765 | 2482 | 1651 | 2476 | 2618 |
| Modulus (psi) | D-638 | 66220 | 79980 | 114540 | 78100 | 116140 | 164660 |
| Break Strain (%) | D-790 | 4.45 | 4.39 | 4.47 | 4.53 | 4.51 | 3.38 |
| Max Energy (in- | D-790 | 78.74 | 94.14 | 118.86 | 96.74 | 123.50 | 109.12 |
| lb/in³) | | | | | | | |
| Max Stress (psi) | D-790 | 2984 | 3520 | 4132 | 3520 | 4194 | 4912 |
| Max Load (lbs) | D-790 | 7.85 | 9.02 | 10.53 | 8.99 | 10.57 | 12.15 |
| Modulus (psi) | D-790 | 106060 | 150460 | 183640 | 132380 | 192960 | 286400 |
| Impact Resistance | D-256 | 5.325 | 2.021 | 1.461 | 2.235 | 1.363 | 1.006 |
| (ft lbs/in) | | | | | | | |
| Bulk density | D-792 | 0.932 | 0.981 | 1.046 | 0.971 | 1.052 | 1.136 |
| (g/cm³) | | | | | | | |

### Example 18

In one experiment biomass (pine wood and sugarcane bagasse) was treated using methods described herein. The fixed carbon concentration was determined for the untreated biomass and the treated biomass. As shown below, the treated biomass had over 100% increase in the concentration of fixed carbon.

TABLE 15

| | Fixed Carbon |
|---|---|
| Biomass | (wt %) |
| Raw untreated pine wood | 12.24 |
| Treated pine wood | 27.95 |
| Raw untreated sugarcane bagasse | 6.09 |
| Treated sugarcane bagasse | 12.66 |

### Example 19

In one experiment, dimensional lumber was treated using methods described herein. Offgassing of chlorine and PCP was reduced by about 99% compared to untreated dimensional lumber.

As used herein, when the term “about” is used in describing a value or an end-point of a range, the disclosure should be understood to include the specific value or end-point referred to. As used herein, the term “about” may include ±10%.

It is to be appreciated that the Detailed Description section, and not any other section, is intended to be used to interpret the claims. Other sections may set forth one or more but not all exemplary embodiments of the present disclosure as contemplated by the inventor(s), and thus, are not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The above examples are illustrative, but not limiting, of the present disclosure. Other suitable modifications and adaptations of the variety of conditions and parameters normally encountered in the field, and which would be apparent to those skilled in the art, are within the spirit and scope of the disclosure.

References in the specification to “one embodiment,” “an embodiment,” “an example embodiment,” “some embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The breadth and scope of the present disclosure should not be limited by any of the above-described exemplary embodiments, but should be defined only in accordance with the claims and their equivalents.

What is claimed is:

1. A method for treating a biomass composition, the method comprising:
providing a biomass composition comprising at least one of lignin, cellulose, hemi-cellulose, pectin, or polysaccharides;
mixing the biomass composition with a reagent to form a mixture, wherein the reagent comprises ammonia;
reacting the mixture for a first time period;
separating a component of the biomass composition to form at least one product, wherein the component comprises at least one of lignin, polylactic acid, carbon oxides, methane, minerals, volatiles, semi-volatiles, graphene, pectin, polysaccharides, hydrocarbons, hemi-cellulose, bio-derived polymer products, torrefied fiber, charred fiber, or liquid biofuel; and
removing the at least one product from the mixture.

2. The method of claim 1, wherein the biomass composition comprises dimensional lumber.

3. The method of claim 1 or 2, wherein the at least one product comprises treated dimensional lumber.

4. The method of any one of claims 1 to 3, wherein the biomass composition comprises raw biomass.

5. The method of any one of claim 1 or 4, wherein the raw biomass comprises green biomass.

6. The method of any one of claims 1 to 5, wherein the biomass composition comprises a waste product.

7. The method of claim 5, wherein the waste product comprises at least one of wood, agricultural residuals, alcohol residuals, industrial waste sludge, paper waste sludge, municipal waste sludge, municipal solid waste digestate, utility poles, dock and mooring support poles and piers, railroad ties, or recycled drywall paper backing.

8. The method of any one of claims 1 to 7, wherein the at least one product comprises a refined biomass composition, wherein the refined biomass composition comprises less lignin than the biomass composition.

9. The method of claim 8, wherein the refined biomass composition comprises at least one of a torrefied pellet, a torrefied cube, or a torrefied chip.

10. The method of any one of claims 1 to 9, wherein the at least one product comprises lignin desorbed from the biomass composition.

11. The method of any one of claims 1 to 10, wherein the at least one product comprises polylactic acid.

12. The method of any one of claims 1 to 11, wherein the at least one product comprises a mineral.

13. The method of any one of claims 1 to 12, wherein the mineral has an increased transmittance as measured by a spectrophotometer.

14. The method of any one of claims 1 to 13, wherein the mineral comprises at least one of potassium, calcium carbonate, titanium dioxide, talc, or aluminum silicate.

15. The method of any one of claims 1 to 14, wherein the reagent comprises at least one of permanganate, sodium permanganate, sodium borohydride, or a solvated electron solution.

16. The method of any one of claims 1 to 15, wherein the reagent is an aqueous solution comprising ammonia.

17. The method of any one of claims 1 to 16, wherein the aqueous solution has an ammonia concentration in a range of about 0.5% to about 100%.

18. The method of any one of claims 1 to 17, wherein the aqueous solution has an ammonia concentration in a range of about 1% to about 19%.

19. The method of any one of claims 1 to 18, wherein the component is lignin, and wherein from about 1% to about 99% of the lignin is separated from the biomass composition.

20. The method of any one of claims 1 to 19, wherein the first time period is from about 2 minutes to about 48 hours.

21. The method of any one of claims 1 to 20, wherein the method produces from about 100 lbs to about 150 tons per hour of the at least one product.

22. The method of any one of claims 1 to 21, wherein the reacting occurs at ambient temperature.

23. The method of any one of claims 1 to 22, wherein the reacting occurs at atmospheric pressure.

24. The method of any one of claims 1 to 23, wherein the reacting is done in a reactor, wherein the reactor has a residence time of about 2 minutes to about 48 hours.

25. The method of any one of claims 1 to 24, wherein the concentration of the component in the biomass composition is greater than the concentration of the component in the first product.

26. The method of any one of claims 1 to 25, comprising providing the biomass composition at a rate of from about 100 lbs to about 150 tons per hour.

27. The method of any one of claims 1 to 26, wherein the carbon oxides comprise at least one of carboxylic acids, carbon dioxide, or carbon monoxide.

28. The method of any one of claims 1 to 27, wherein the minerals comprise oxidized minerals.

29. The method of any one of claims 1 to 28, wherein the volatiles comprise at least one of hydrocarbons, terpenes, terpenoids, flavonoids, alcohols, aldehydes, and ketones.

30. The method of any one of claims 1 to 29, wherein the semi-volatiles comprise at least one of hydrocarbons, aldehydes, ethers, esters, phenols, organic acids, ketones, amines, amides, nitroaromatics, polychlorinated biphenyls, polycyclic aromatic hydrocarbons, phthalate esters, nitrosamines, haloethers and trihalomethanes.

31. The method of any one of claims 1 to 30, wherein the calorific heating value of the at least one product is greater than the calorific heating value of the biomass composition.

32. The method of any one of claims 1 to 31, wherein the density of the at least one product is greater than the density of the biomass composition.

33. The method of any one of claims 1 to 32, wherein the at least one product comprises fewer fine particles.

34. The method of any one of claims 1 to 33, wherein the at least one product comprises a higher hydrophobicity than the biomass composition.

35. The method of any one of claims 1 to 34, wherein the at least one product comprises a hydrophobicity such that it does not spontaneously combust.

36. The method of any one of claims 1 to 35, wherein the biomass composition has a fixed carbon concentration that is less than a fixed carbon concentration of the at least one product.

37. The method of any one of claims 1 to 36, wherein the at least one product has a cellulose concentration greater than a cellulose concentration of the biomass composition.

38. The method of any one of claims 1 to 37, wherein the cellulose concentration in the at least one product is at least about 100% greater than the cellulose concentration of the biomass composition.

39. The method of any one of claims 1 to 38, wherein the cellulose concentration in the at least one product is about 100% to about 200% greater than the cellulose concentration of the biomass composition.

40. The method of any one of claims 1 to 39, wherein the reacting the mixture for a first time period comprises hydrogen donation, hydrogen bonding, and hydrogen cleaving.

41. The method of any one of claims 1 to 40, wherein the hydrogen donation comprises displacing and transforming carbon oxides in the biomass composition into ammonia salts.

42. The method of any one of claims 1 to 41, wherein the hydrogen donation and hydrogen cleaving increases the conversion of Type C1 crystalline polymorphs to Type CIII crystalline polymorphs.

43. The method of any one of claims 1 to 42, wherein the hydrogen donation, hydrogen bonding, and hydrogen cleaving in part enables reactions that result in improved strength of mechanical properties and more rapid digestion of the at least one product compared to the biomass composition.

44. The method of any one of claims 1 to 43, wherein the hydrogen donation, hydrogen bonding, and hydrogen cleaving allows for hemp decortication, penetration, and decoupling, softening, fiber-polymer compatibility, and conditioning of the fiber.

45. The method of any one of claims 1 to 44, wherein the at least one product comprises ammonia, and wherein a concentration of ammonia in the at least one product is greater than a concentration of ammonia in the biomass composition.

46. The method of any one of claims 1 to 45, wherein the at least one product is a combustible product comprising ammonia, and wherein the combustible product, when combusted, emits less greenhouse gases than the biomass composition emits when combusted.

47. The method of any one of claims 1 to 46, wherein the method is a continuous flow process.

48. The method of any one of claims 1 to 47, wherein the at least one product is used for production of a plastic, and wherein the cycle time during production of the plastic is reduced by at least about 30%.

49. A heating pellet produced using the at least one product of any one of claims 1 to 48.

50. A heating cube produced using the at least one product of any one of claims 1 to 48.

51. A heating chip produced using the at least one product of any one of claims 1 to 48.

52. A plastic produced using the at least one product of any one of claims 1 to 48.

53. The plastic of claim 51, wherein the plastic is a recyclable bioplastic.

54. A wood composite produced using the at least one product of any one of claims 1 to 48.

55. A fuel produced using the at least one product of any one of claims 1 to 48.

56. An additive produced using the at least one product of any one of claims 1 to 48, wherein the additive is a concrete additive or a cement additive.

57. A method of decarbonizing a biomass composition, the method comprising treating the biomass composition according to the method of any one of claims 1 to 48.

58. The method of claim 57, wherein the biomass composition has a fixed carbon concentration that is less than a fixed carbon concentration of the at least one product.

59. A method of removing a pollutant from a biomass composition, the method comprising treating the biomass composition according to the method of any one of claims 1 to 48.

60. The method of claim 59, wherein the pollutant comprises at least one of carboxylic acids, carbon oxides, carbon dioxide, carbon monoxide, methane, oxidized minerals, volatiles, or semi-volatiles, pentachlorophenol (PCP), creosote, chlorine, arsenic, short chain hydrocarbons, long chain hydrocarbons, per- and polyfluoroalkyl substances (PFAS), and/or perfluorooctane sulfonic acid (PFOS).

61. A method for producing one or more products from a biomass composition, the method comprising:
mixing the biomass composition with a reagent to produce a treated biomass composition, wherein the reagent is an aqueous solution comprising ammonia;
drying the treated biomass composition to produce at least one product and a gas, wherein the at least one product comprises a first product with a lower CO₂-e concentration and a lower carbon oxide concentration than the biomass composition; and
contacting the gas with an absorbent to absorb carbon oxides from the gas, wherein the contacting the gas comprises spraying the absorbent over the gas to absorb carbon oxides in the gas and produce a recycle stream and an exhaust gas stream, wherein the exhaust gas stream comprises less than about 1% concentration of greenhouse gases.

62. The method of claim 61, wherein the time required to dry the treated biomass composition is less than the time required to dry the biomass composition.

63. The method of claim 61 or 62, wherein the energy required to dry the treated biomass composition is less than the energy required to dry the biomass composition.

64. The method of any one of claims 61 to 63, wherein the biomass composition comprises at least one of lignin, cellulose, hemicellulose, or pectin.

65. The method of any one of claims 61 to 64, wherein the biomass composition comprises at least one of wood, agricultural residuals, alcohol residuals, industrial waste sludge, paper waste sludge, municipal waste sludge, municipal solid waste digestate, utility poles, dock and mooring support poles and piers, railroad ties, or recycled drywall paper backing.

66. The method of any one of claims 61 to 65, further comprising extracting lignin from the biomass composition.

67. The method of any one of claims 61 to 66, wherein the aqueous solution has an ammonia concentration in a range of about 1% to about 19%.

68. The method of any one of claims 61 to 67, further comprising:
detecting the concentration of the ammonia in the aqueous solution;
determining that the concentration of the ammonia in the aqueous solution is less than a predetermined threshold; and
adding ammonia to the aqueous solution.

69. The method of any one of claims 61 to 68, wherein the at least one product comprises ammonia in a concentration from about 0.1% to about 5%.

70. The method of any one of claims 61 to 69, wherein the absorbent comprises ammonium hydroxide.

71. The method of claim 70, wherein the ammonium hydroxide is atomized.

72. The method of claim 70, wherein at least a portion of the ammonia hydroxide is recycled to the reagent.

73. The method of any one of claims 61 to 72, further comprising atomizing the absorbent before contacting the exhaust gas with the absorbent.

74. The method of any one of claims 61 to 73, wherein the carbon oxide comprises at least one of carbon dioxide, carbon monoxide, methane, or carboxylic acid.

75. The method of any one of claims 61 to 74, further comprising mechanically dewatering by applying pressure to the biomass composition to remove moisture from the biomass composition before mixing it with the reagent.

76. The method of any one of claims 61 to 75, further comprising diluting the reagent before mixing it with the biomass composition.

77. The method of claim 76, further comprising recirculating the recycle stream to dilute or regenerate the reagent.

78. The method of any one of claims 61 to 77, wherein the method is carbon neutral or carbon negative.

79. The method of any one of claims 61 to 78, further comprising processing the at least one product to form at least one of a plastic, a wood composite, automotive components, cement additives, concrete additives, renewable fuel, or a fertilizer.

80. The method of any one of claims 61 to 79, wherein the at least one product has a higher calorific heating value than the biomass composition.

81. The method of any one of claims 61 to 80, wherein the at least one product has a bulk density that is greater than a bulk density of the biomass composition.

82. The method of any one of claims 61 to 81, wherein the at least one product has an energy density that is greater than an energy density of the biomass composition.

83. The method of any one of claims 61 to 82, wherein the method captures about 50% to about 90% of the carbon dioxide or carbon dioxide-equivalent compounds in the biomass composition.

84. A heating pellet produced using the at least one product of any one of claims 61 to 83.

85. A heating cube produced using the at least one product of any one of claims 61 to 83.

86. A heating chip produced using the at least one product of any one of claims 61 to 83.

87. A plastic produced using the at least one product of any one of claims 61 to 83.

88. The plastic of claim 87, wherein the plastic is a recyclable bioplastic.

89. A wood composite produced using the at least one product of any one of claims 61 to 83.

90. A fuel produced using the at least one product of any one of claims 61 to 83.

91. The fuel of claim 90, wherein the fuel is a nitrogen enhanced and hydrogen enhanced fuel.

92. The fuel of claim 90, wherein the fuel comprises one or more of liquid biocrude fuel, renewable diesel fuel, or drop-in fuel.

93. An additive produced using the at least one product of any one of claims 61 to 83, wherein the additive is a concrete additive or a cement additive.

94. A system for producing products from a biomass composition, comprising:
a feed system configured to feed the biomass composition;
a mixer configured to mix the biomass composition and a reagent to form a mixture, wherein the reagent comprises ammonia;
a dryer configured to dry the mixture to produce a first product and gas; and
a spray tower configured to contact the gas with an absorbent to absorb carbon oxides from the gas to form a recycle stream and an exhaust gas, wherein the exhaust gas comprises less than about 1% greenhouse gases.

95. The system of claim 94, wherein the biomass composition comprises at least one of wood, agricultural residuals, alcohol residuals, industrial waste sludge, paper waste sludge, municipal waste sludge, municipal solid waste digestate, utility poles, dock and mooring support poles and piers, railroad ties, or recycled drywall paper backing.

96. The system of claim 94 or 95, wherein the absorbent comprises ammonium hydroxide.

97. The system of claim 96, wherein the ammonium hydroxide is atomized.

98. The system of claim 97, wherein the spray tower is configured to spray the ammonium hydroxide to contact the gas such that the absorbent absorbs the carbon oxides from the gas.

99. The system of any one of claims 94 to 98, further comprising a reagent tank for storing the reagent.

100. The system of claim 99, further comprising a dilution tank configured to dilute the reagent to form a diluted reagent.

101. The system of claim 100, wherein the mixer is configured to receive the biomass composition from the feed system and to receive the diluted reagent from the dilution tank.

102. The system of any one of claims 94 to 101, further comprising a filter configured to capture dust from the exhaust gas.

103. The system of any one of claims 94 to 102, further comprising a press configured to apply pressure to the biomass composition to reduce the moisture content of the biomass composition.

104. The system of any one of claims 94 to 103, wherein the feed system is configured to receive the biomass composition from an industrial process waste stream.

105. The system of claim 104, wherein the industrial process comprises at least one of a pulp and paper process, heating pellet production, construction materials production, automotive materials manufacturing, plastics production, or a power generation facility.

106. The system of any one of claims 94 to 105, further comprising a grinding apparatus configured to reduce the particle size of the first product to less than about 100 μm.

107. A method of decarbonizing a biomass composition using the system of any one of claims 94 to 106.

108. A phytosanitary wood chip produced using the system of any one of claims 94 to 107.
